(19) United States
(12) Patent Application Publication
(10) Pub. No.: US 2026/0254353 A1
(43) Pub. Date: Aug. 27, 2026

(54) MULTILAYER SUBSTRATE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Keisuke SUZUKI, Nisshin-shi (JP); Tomonori KIMURA, Nisshin-shi (JP)

(21) Appl. No.: 19/529,619

(22) Filed: Feb. 4, 2026

(30) Foreign Application Priority Data
Feb. 21, 2025 (JP) 2025-026871

(51) Int. Cl. H02M 3/00; H01F 27/28; H01F 27/32; H02M 3/335

(52) U.S. Cl. CPC H02M 3/003; H01F 27/2804; H01F 27/324; H02M 3/33573; H02M 3/33584; H02M 3/33592; H01F 2027/2809

(57) ABSTRACT

A multilayer substrate includes a first substrate, a second substrate, a transformer including a primary winding and a secondary winding, a first reactor connected to a first end of the transformer, and a second reactor connected to a second end of the transformer. The primary winding includes a primary-side first winding portion and a primary-side second winding portion. The secondary winding includes a secondary-side first winding portion and a secondary-side second winding portion. The first substrate and the second substrate are arranged in the thickness direction. The primary-side first winding portion and the secondary-side first winding portion are disposed on the first substrate. The primary-side second winding portion and the secondary-side second winding portion are disposed on the second substrate.

### CROSS REFERENCE TO RELATED APPLICATION

The present application claims the benefit of priority from Japanese Patent Application No. 2025-026871 filed on Feb. 21, 2025. The entire disclosure of the above application is incorporated herein by reference.

### TECHNICAL FIELD

The present disclosure relates to a multilayer substrate.

### BACKGROUND

Conventionally, a switching power supply apparatus is known that includes a transformer, a full-bridge switching circuit, a leakage inductance, an output circuit, and a control circuit.

### SUMMARY

A multilayer substrate according to one aspect of the present disclosure includes a first substrate, a second substrate, a transformer including a primary winding and a secondary winding and having a first end and a second end, a first reactor connected to the first end of the transformer, and a second reactor connected to the second end of the transformer. The primary winding includes a primary-side first winding portion and a primary-side second winding portion. The secondary winding includes a secondary-side first winding portion and a secondary-side second winding portion. The primary-side first winding portion, the primary-side second winding portion, the secondary-side first winding portion, and the secondary-side second winding portion are formed in a spiral shape extending on a plane orthogonal to a thickness direction of the first substrate. The first substrate and the second substrate are arranged in the thickness direction. The primary-side first winding portion may be disposed on one surface of the first substrate, and the secondary-side first winding portion may be disposed on another surface of the first substrate that is opposite to the one surface on which the primary-side first winding portion is disposed. The primary-side second winding portion may be disposed on one surface of the second substrate, and the secondary-side second winding portion may be disposed on another surface of the second substrate that is opposite to the one surface on which the primary-side second winding portion is disposed.

### BRIEF DESCRIPTION OF DRAWINGS

Objects, features and advantages of the present disclosure will become apparent from the following detailed description made with reference to the accompanying drawings. In the drawings:

FIG. 1 is a circuit diagram of a dual active bridge (DAB) converter using a multilayer substrate according to a first embodiment;

FIG. 2 is a time chart illustrating an operation of the DAB converter;

FIG. 3 is a perspective view of a multilayer substrate;

FIG. 4 is a perspective view of the multilayer substrate;

FIG. 5 is a top view of a core of the multilayer substrate;

FIG. 6 is an enlarged cross-sectional view taken along line VI-VI in FIG. 3;

FIG. 7 is a top view of a primary-side first winding portion of a primary winding in the multilayer substrate;

FIG. 8 is a top view of a primary-side second winding portion of the primary winding;

FIG. 9 is a circuit diagram of a multilayer substrate;

FIG. 10 is a top view of a secondary-side first winding portion of a secondary winding in the multilayer substrate;

FIG. 11 is a top view of a secondary-side second winding portion of the secondary winding;

FIG. 12 is a circuit diagram of a multilayer substrate according to a comparative example;

FIG. 13 is a view illustrating temporal changes in voltage at transformer ends in the multilayer substrate;

FIG. 14 is a view illustrating temporal changes in voltage difference at the transformer ends in the multilayer substrate;

FIG. 15 is a table illustrating amounts of change in voltage difference at the transformer ends in the multilayer substrate;

FIG. 16 is a diagram illustrating a relationship between an output current of the DAB converter and a temperature of the core;

FIG. 17 is a view illustrating temporal changes in voltage and voltage difference at the transformer ends in the multilayer substrate;

FIG. 18 is a diagram illustrating a relationship between a ratio of an inductance of a reactor to leakage inductance of a transformer and a sum of absolute values of the amounts of change in voltage difference at the transformer end in the multilayer substrate;

FIG. 19 is a circuit diagram of a multilayer substrate according to a second embodiment;

FIG. 20 is a circuit diagram of a multilayer substrate according to a third embodiment;

FIG. 21 is a circuit diagram of a multilayer substrate according to a fourth embodiment;

FIG. 22 is a circuit diagram of a multilayer substrate according to a fifth embodiment;

FIG. 23 is a circuit diagram of a multilayer substrate according to a sixth embodiment;

FIG. 24 is a circuit diagram of a multilayer substrate according to a seventh embodiment;

FIG. 25 is a circuit diagram of a multilayer substrate according to an eighth embodiment;

FIG. 26 is a circuit diagram of a multilayer substrate according to a ninth embodiment;

FIG. 27 is a circuit diagram of a multilayer substrate according to a tenth embodiment;

FIG. 28 is a circuit diagram of a multilayer substrate according to an eleventh embodiment;

FIG. 29 is a cross-sectional view of a multilayer substrate according to a twelfth embodiment;

FIG. 30 is a cross-sectional view of a multilayer substrate according to a thirteenth embodiment;

FIG. 31 is a circuit diagram of the multilayer substrate;

FIG. 32 is a cross-sectional view of a multilayer substrate according to a fourteenth embodiment;

FIG. 33 is a cross-sectional view of a multilayer substrate according to a fifteenth embodiment;

FIG. 34 is a circuit diagram of the multilayer substrate;

FIG. 35 is a cross-sectional view of a multilayer substrate according to a sixteenth embodiment;

FIG. 36 is a cross-sectional view of a multilayer substrate according to a seventeenth embodiment;

FIG. 37 is a cross-sectional view of a multilayer substrate according to an eighteenth embodiment;

FIG. 38 is a cross-sectional view of a multilayer substrate according to a nineteenth embodiment;

FIG. 39 is a circuit diagram of a multilayer substrate according to a twentieth embodiment;

FIG. 40 is a circuit diagram of a multilayer substrate according to a twenty-first embodiment;

FIG. 41 is a cross-sectional view of a multilayer substrate according to a twenty-second embodiment;

FIG. 42 is a cross-sectional view of a multilayer substrate according to a twenty-third embodiment;

FIG. 43 is a cross-sectional view of a multilayer substrate according to a twenty-fourth embodiment;

FIG. 44 is a cross-sectional view of a multilayer substrate according to a twenty-fifth embodiment;

FIG. 45 is a cross-sectional view of a multilayer substrate according to a twenty-sixth embodiment; and

FIG. 46 is a cross-sectional view of a multilayer substrate according to a twenty-seventh embodiment.

### DETAILED DESCRIPTION

A switching power supply apparatus according to a related art includes a transformer, a full-bridge switching circuit, a leakage inductance, an output circuit, and a control circuit. The full-bridge switching circuit includes first and second arms connected in parallel with an input power supply. Each arm includes a series configuration of a high-potential-side switch and a low-potential-side switch, and a diode and a capacitor configured in parallel with each switch. The leakage inductance is present in a current path between an interconnection portion of the high-potential-side switch and the low-potential-side switch in one arm of the switching circuit and a primary-side winding of the transformer. The output circuit is provided on the secondary side of the transformer. The control circuit controls the operation timing of each switch of the switching circuit by a phase shift control method. An external inductor is connected to the current path between the switching circuit and the primary-side winding of the transformer, and an external switch is connected in parallel with the external inductor. Furthermore, when the load is light, the control circuit turns off the external switch to connect the external inductor to the current path, and when the load is heavy, the control circuit turns on the external switch to electrically short-circuit the external inductor. As a result, the control circuit increases the leakage inductance when the load is light, and decreases the leakage inductance when the load is heavy.

In the switching power supply apparatus, a change in voltage at the transformer end to which the external inductor is connected becomes relatively large. Thus, a change in voltage applied to winding capacitance included in the transformer increases. When the change in voltage applied to the winding capacitance of the transformer is large, the current flowing through the winding capacitance of the transformer increases. When the current flowing through the winding capacitance of the transformer is large, for example, the loss of the core included in the transformer increases. Moreover, when the frequency of switching is increased, the increase in core loss becomes significant. Since the voltage applied to the transformer increases, for example, the transformer tends to be damaged when the voltage of the transformer becomes equal to or higher than the withstand voltage of the transformer. Therefore, in the switching power supply apparatus, since the change in voltage at the transformer end to which the external inductor is connected is relatively large, an increase in core loss, damage to the transformer, and the like tend to occur.

A multilayer substrate according to one aspect of the present disclosure includes a first substrate, a second substrate, a transformer including a primary winding and a secondary winding and having a first end and a second end, a first reactor connected to the first end of the transformer, and a second reactor connected to the second end of the transformer. The primary winding includes a primary-side first winding portion and a primary-side second winding portion. The secondary winding includes a secondary-side first winding portion and a secondary-side second winding portion. The primary-side first winding portion, the primary-side second winding portion, the secondary-side first winding portion, and the secondary-side second winding portion are formed in a spiral shape extending on a plane orthogonal to a thickness direction of the first substrate. The first substrate and the second substrate are arranged in the thickness direction. The primary-side first winding portion is disposed on one surface of the first substrate, and the secondary-side first winding portion is disposed on another surface of the first substrate that is opposite to the one surface on which the primary-side first winding portion is disposed. The primary-side second winding portion is disposed on one surface of the second substrate, and the secondary-side second winding portion is disposed on another surface of the second substrate that is opposite to the one surface on which the primary-side second winding portion is disposed.

Thus, as compared with the case where one reactor is provided, the amount of change in voltage at one end of the primary winding becomes smaller by values related to the inductances of the first reactor and the second reactor and to the amount of change in voltage at one end of the secondary winding. For this reason, a change in voltage at the transformer end is suppressed.

Embodiments will be described with reference to the drawings. In the following embodiments, the same or equivalent portions are denoted by the same reference numerals, and the description thereof will be omitted.

### First Embodiment

The multilayer substrate of the present embodiment suppresses a change in voltage at the transformer end. This multilayer substrate is used, for example, in a DAB converter. First, the DAB converter will be described. DAB is an abbreviation for Dual Active Bridge.

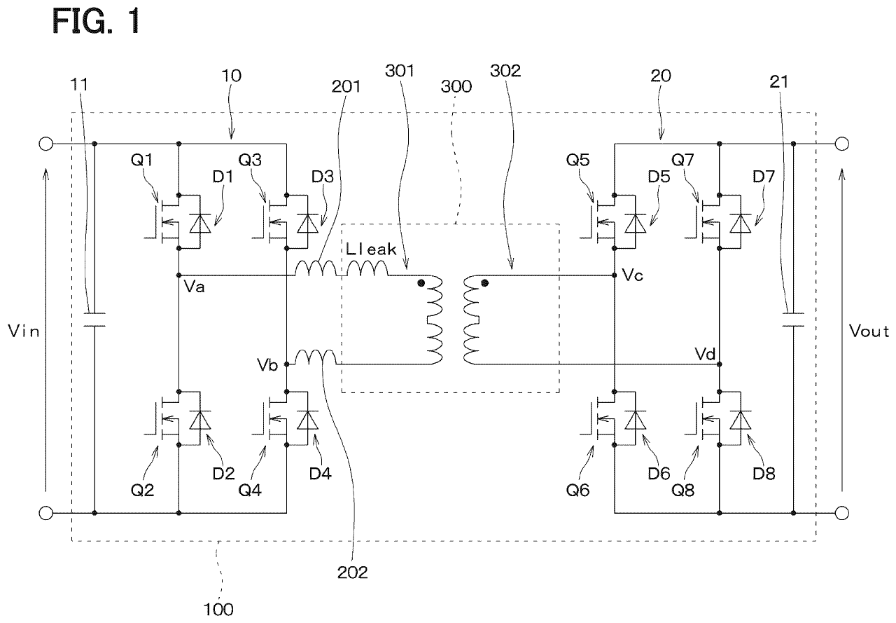

As illustrated in FIG. 1, the DAB converter includes a primary-side bridge circuit 10, an input capacitor 11, a secondary-side bridge circuit 20, an output capacitor 21, and a multilayer substrate 100.

The primary-side bridge circuit 10 includes a first switching element Q1, a second switching element Q2, a third switching element Q3, and a fourth switching element Q4. Therefore, the primary-side bridge circuit 10 is configured as a full-bridge circuit. The primary-side bridge circuit 10 includes a first freewheeling diode D1, a second freewheeling diode D2, a third freewheeling diode D3, and a fourth freewheeling diode D4.

The first switching element Q1, the second switching element Q2, the third switching element Q3, and the fourth switching element Q4 are, for example, semiconductor elements such as MOSFETs. Furthermore, the first switching element Q1, the second switching element Q2, the third switching element Q3, and the fourth switching element Q4 are connected to a control device (not illustrated). The first switching element Q1, the second switching element Q2, the third switching element Q3, and the fourth switching element Q4 are turned on and off by a gate signal from the control device.

Moreover, the first switching element Q1 and the second switching element Q2 are connected in series. The third switching element Q3 and the fourth switching element Q4 are connected in series. The first switching element Q1 and the third switching element Q3 are connected to so-called P-end-side wiring. The second switching element Q2 and the fourth switching element Q4 are connected to so-called N-end-side wiring.

The first freewheeling diode D1 is connected in parallel with the first switching element Q1. The second freewheeling diode D2 is connected in parallel with the second switching element Q2. The third freewheeling diode D3 is connected in parallel with the third switching element Q3. The fourth freewheeling diode D4 is connected in parallel with the fourth switching element Q4.

The input capacitor 11 is connected in parallel with the first switching element Q1 and the second switching element Q2. Furthermore, the input capacitor 11 is connected in parallel with the third switching element Q3 and the fourth switching element Q4.

The secondary-side bridge circuit 20 includes a fifth switching element Q5, a sixth switching element Q6, a seventh switching element Q7, and an eighth switching element Q8. Therefore, the secondary-side bridge circuit 20 is configured as a full-bridge circuit. The secondary-side bridge circuit 20 includes a fifth freewheeling diode D5, a sixth freewheeling diode D6, a seventh freewheeling diode D7, and an eighth freewheeling diode D8.

The fifth switching element Q5, the sixth switching element Q6, the seventh switching element Q7, and the eighth switching element Q8 are, for example, semiconductor elements such as MOSFETs. Furthermore, the fifth switching element Q5, the sixth switching element Q6, the seventh switching element Q7, and the eighth switching element Q8 are connected to the control device (not illustrated). The fifth switching element Q5, the sixth switching element Q6, the seventh switching element Q7, and the eighth switching element Q8 are turned on and off by a gate signal from the control device.

Moreover, the fifth switching element Q5 and the sixth switching element Q6 are connected in series. The seventh switching element Q7 and the eighth switching element Q8 are connected in series. The fifth switching element Q5 and the seventh switching element Q7 are connected to the P-end-side wiring. The sixth switching element Q6 and the eighth switching element Q8 are connected to the N-end-side wiring.

The fifth freewheeling diode D5 is connected in parallel with the fifth switching element Q5. The sixth freewheeling diode D6 is connected in parallel with the sixth switching element Q6. The seventh freewheeling diode D7 is connected in parallel with the seventh switching element Q7. The eighth freewheeling diode D8 is connected in parallel with the eighth switching element Q8.

The output capacitor 21 is connected in parallel with the fifth switching element Q5 and the sixth switching element Q6. Furthermore, the output capacitor 21 is connected in parallel with the seventh switching element Q7 and the eighth switching element Q8.

The multilayer substrate 100 includes a first reactor 201, a second reactor 202, a transformer 300, and the like. Details of the multilayer substrate 100 will be described later.

One end of the first reactor 201 is connected between the first switching element Q1 and the second switching element Q2.

One end of the second reactor 202 is connected between the third switching element Q3 and the fourth switching element Q4.

The transformer 300 includes a primary winding 301 and a secondary winding 302. One end of the primary winding 301 is connected to the other end of the first reactor 201. The other end of the primary winding 301 is connected to the other end of the second reactor 202.

One end of the secondary winding 302 is connected between the fifth switching element Q5 and the sixth switching element Q6. The other end of the secondary winding 302 is connected between the seventh switching element Q7 and the eighth switching element Q8.

The polarity of the transformer 300 is set to be the same polarity. Therefore, when a voltage is applied to the primary winding 301, the polarity of the voltage at the one end of the primary winding 301 becomes identical to the polarity of the voltage at the one end of the secondary winding 302. When a voltage is applied to the primary winding 301, the polarity of the voltage at the other end of the primary winding 301 becomes identical to the polarity of the voltage at the other end of the secondary winding 302. When a voltage is applied to the primary winding 301, the polarity of the voltage at the one end of the primary winding 301 is opposite to the polarity of the voltage at the other end of the secondary winding 302.

Furthermore, the transformer 300 has a leakage inductance. Here, the leakage inductance of the transformer 300 is assumed to be present between the one end of the primary winding 301 and the other end of the first reactor 201.

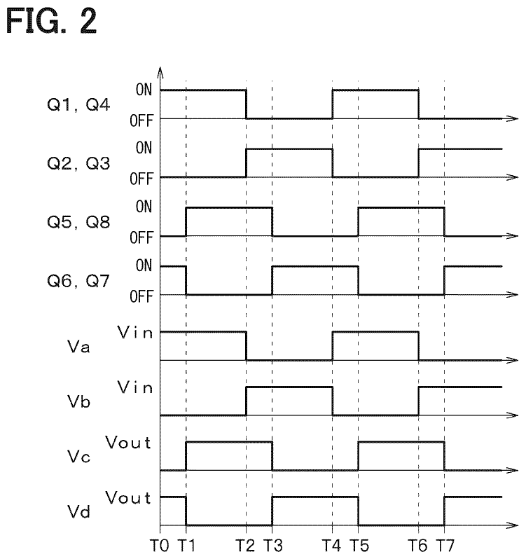

As described above, the DAB converter using the multilayer substrate 100 of the first embodiment is configured. Next, the operation of the DAB converter will be described with reference to a time chart of FIG. 2.

As illustrated in the time chart of FIG. 2, the first switching element Q1, the second switching element Q2, the third switching element Q3, and the fourth switching element Q4 are switched at a duty ratio of 50% by the control device (not illustrated). The fifth switching element Q5, the sixth switching element Q6, the seventh switching element Q7, and the eighth switching element Q8 are switched at a duty ratio of 50%.

The on and off phases of the first switching element Q1 and the fourth switching element Q4 are set to be identical. The on and off phases of the second switching element Q2 and the third switching element Q3 are set to be identical. The on and off phases of the fifth switching element Q5 and the eighth switching element Q8 are set to be identical. The on and off phases of the sixth switching element Q6 and the seventh switching element Q7 are set to be identical.

Furthermore, the difference between the on and off phases of the first switching element Q1 and the fourth switching element Q4 and the on and off phases of the second switching element Q2 and the third switching element Q3 is set to 180°. The difference between the on and off phases of the fifth switching element Q5 and the eighth switching element Q8 and the on and off phases of the sixth switching element Q6 and the seventh switching element Q7 is set to 180°.

A certain difference is provided between the on and off phases of the first switching element Q1 and the fourth switching element Q4 and the on and off phases of the fifth switching element Q5 and the eighth switching element Q8. A certain difference is provided between the on and off phases of the second switching element Q2 and the third switching element Q3 and the on and off phases of the sixth switching element Q6 and the seventh switching element Q7.

Here, as illustrated in FIG. 1, the voltage input to the primary-side bridge circuit 10 is defined as Vin. The voltage output from the secondary-side bridge circuit 20 is defined as Vout.

Vin is raised and lowered to Vout by the transformer 300. When a ratio of turns (that is, the number of windings) of the secondary winding 302 to turns of the primary winding 301 is defined as N, Vout is set to N×Vin. Therefore, for example, when the turns of the primary winding 301 are set to 8 and the turns of the secondary winding 302 are set to 5, N=5/8, and thus Vout=5/8×Vin.

Here, a voltage between the first switching element Q1 and the second switching element Q2 is defined as Va. A voltage between the third switching element Q3 and the fourth switching element Q4 is defined as Vb. A voltage between the fifth switching element Q5 and the sixth switching element Q6 is defined as Vc. A voltage between the seventh switching element Q7 and the eighth switching element Q8 is defined as Vd.

Returning to the time chart of FIG. 2, it is assumed that the first switching element Q1 and the fourth switching element Q4 are turned on at time T0. At this time, the second switching element Q2 and the third switching element Q3 are turned off. The fifth switching element Q5 and the eighth switching element Q8 are turned off. The sixth switching element Q6 and the seventh switching element Q7 are turned on.

At time T1 after time T0, the first switching element Q1 and the fourth switching element Q4 remain on. The second switching element Q2 and the third switching element Q3 remain off. The fifth switching element Q5 and the eighth switching element Q8 are turned on from off. The sixth switching element Q6 and the seventh switching element Q7 are turned off from on.

At time T2 after time T1, the first switching element Q1 and the fourth switching element Q4 are turned off from on. The second switching element Q2 and the third switching element Q3 are turned on from off. The fifth switching element Q5 and the eighth switching element Q8 remain on. The sixth switching element Q6 and the seventh switching element Q7 remain off.

At time T3 after time T2, the first switching element Q1 and the fourth switching element Q4 remain off. The second switching element Q2 and the third switching element Q3 remain on. The fifth switching element Q5 and the eighth switching element Q8 are turned off from on. The sixth switching element Q6 and the seventh switching element Q7 are turned on from off.

At time T4 after time T3, the first switching element Q1 and the fourth switching element Q4 are turned on from off. The second switching element Q2 and the third switching element Q3 are turned off from on. The fifth switching element Q5 and the eighth switching element Q8 remain off. The sixth switching element Q6 and the seventh switching element Q7 remain on.

At time T5 after time T4, the first switching element Q1 and the fourth switching element Q4 remain on. The second switching element Q2 and the third switching element Q3 remain off. The fifth switching element Q5 and the eighth switching element Q8 are turned on from off. The sixth switching element Q6 and the seventh switching element Q7 are turned off from on.

At time T6 after time T5, the first switching element Q1 and the fourth switching element Q4 are turned off from on. The second switching element Q2 and the third switching element Q3 are turned on from off. The fifth switching element Q5 and the eighth switching element Q8 remain on. The sixth switching element Q6 and the seventh switching element Q7 remain off.

At time T7 after time T6, the first switching element Q1 and the fourth switching element Q4 remain off. The second switching element Q2 and the third switching element Q3 remain on. The fifth switching element Q5 and the eighth switching element Q8 are turned off from on. The sixth switching element Q6 and the seventh switching element Q7 are turned on from off.

By these on/off operations, Va is Vin between time T0 and time T2 and between time T4 and time T6. Vb is Vin between time T2 and time T4 and at time T6 and thereafter. Vc is Vout between time T1 and time T3 and between time T5 and time T7. Vd is Vout between time T3 and time T5 and at time T7 and thereafter. Vout is output from the secondary-side bridge circuit 20.

As described above, the DAB converter operates. Next, the multilayer substrate 100 will be described in detail.

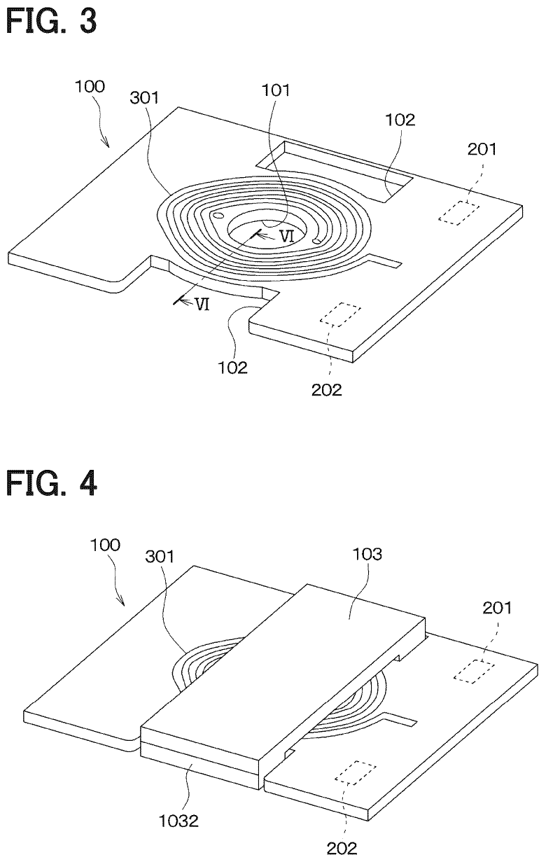

The multilayer substrate 100 is mounted with a primary-side bridge circuit 10, an input capacitor 11, a secondary-side bridge circuit 20, and an output capacitor 21, although these components are not illustrated to avoid complexity. As illustrated in FIGS. 3 to 11, the multilayer substrate 100 includes a through hole 101, a mounting hole 102, an ER core 103, a first substrate 110, a second substrate 120, a third substrate 130, a fourth substrate 140, and a fifth substrate 150. The multilayer substrate 100 further includes a first reactor 201, a second reactor 202, and a transformer 300. In addition, the multilayer substrate 100 has a first winding capacitance C1, a second winding capacitance C2, and a third winding capacitance C3.

As illustrated in FIG. 3, the through hole 101 penetrates the multilayer substrate 100. Furthermore, the through hole 101 is formed, for example, in a central portion of the multilayer substrate 100. Two mounting holes 102 are formed to sandwich the through hole 101.

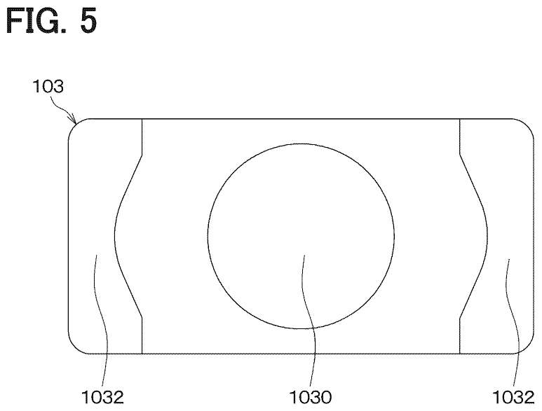

As illustrated in FIGS. 4 and 5, the ER core 103 includes a center pole 1030 and a mounting leg 1032. The center pole 1030 is inserted into the through hole 101. Therefore, the ER core 103 penetrates the first substrate 110, the second substrate 120, the third substrate 130, the fourth substrate 140, and the fifth substrate 150 to be described later, and is surrounded by the primary winding 301 and the secondary winding 302 to be described later. The mounting leg 1032 is inserted into the mounting hole 102. Thus, the ER core 103 is mounted on the multilayer substrate 100.

The first substrate 110, the second substrate 120, the third substrate 130, the fourth substrate 140, and the fifth substrate 150 are formed of, for example, a glass epoxy resin such as FR4. FR4 is an abbreviation for Flame Retardant Type 4. Hereinafter, the thickness direction of the first substrate 110 is simply referred to as a thickness direction DT.

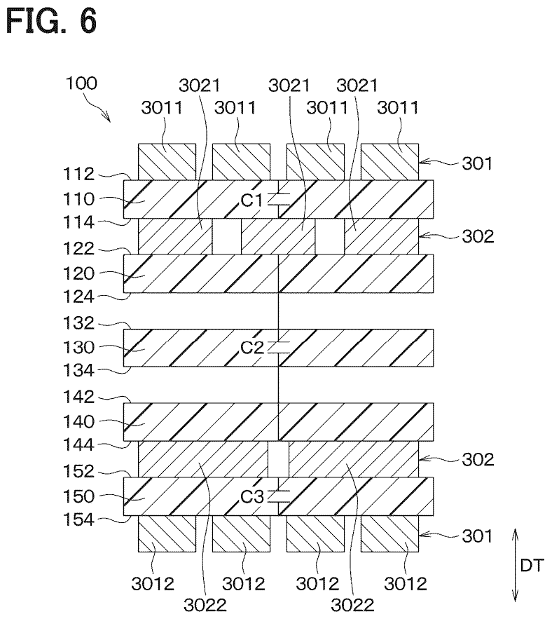

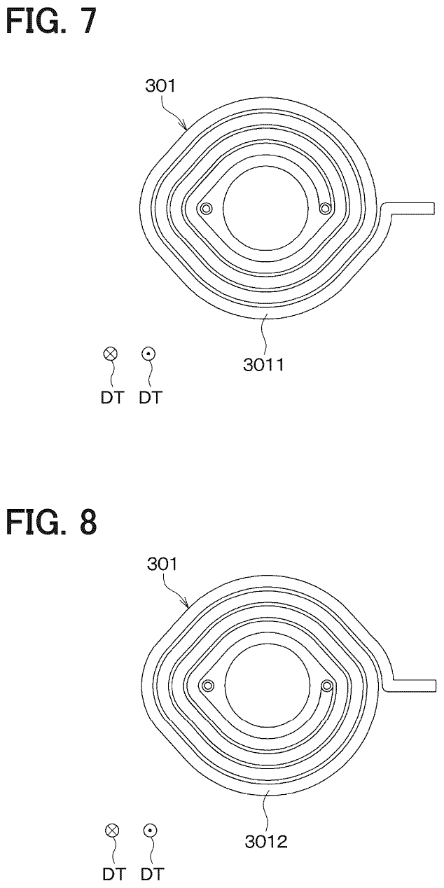

Moreover, as illustrated in FIG. 6, the first substrate 110, the second substrate 120, the third substrate 130, the fourth substrate 140, and the fifth substrate 150 are arranged in this order in the thickness direction DT. Therefore, the second substrate 120, the third substrate 130, and the fourth substrate 140 are formed between the first substrate 110 and the fifth substrate 150.

Although not illustrated to avoid complexity, a resin such as a prepreg is embedded between the first substrate 110 and the second substrate 120. A resin such as a prepreg is embedded between the second substrate 120 and the third substrate 130. A resin such as a prepreg is embedded between the third substrate 130 and the fourth substrate 140. A resin such as a prepreg is embedded between the fourth substrate 140 and the fifth substrate 150.

Moreover, the first substrate 110 has a first front surface 112 and a first rear surface 114. The first front surface 112 is a surface of the first substrate 110 on one side in the thickness direction DT. The first rear surface 114 is a surface of the first substrate 110 on the other side in the thickness direction DT, and is a surface of the first substrate 110 opposite to the first front surface 112.

The second substrate 120 has a second front surface 122 and a second rear surface 124. The second front surface 122 is a surface of the second substrate 120 on one side in the thickness direction DT, and faces the first rear surface 114 in the thickness direction DT. The second rear surface 124 is a surface of the second substrate 120 on the other side in the thickness direction DT, and is a surface of the second substrate 120 opposite to the second front surface 122.

The third substrate 130 has a third front surface 132 and a third rear surface 134. The third front surface 132 is a surface of the third substrate 130 on one side in the thickness direction DT, and faces the second rear surface 124 in the thickness direction DT. The third rear surface 134 is a surface of the third substrate 130 on the other side in the thickness direction DT, and is a surface of the third substrate 130 opposite to the third front surface 132.

The fourth substrate 140 has a fourth front surface 142 and a fourth rear surface 144. The fourth front surface 142 is a surface of the fourth substrate 140 on one side in the thickness direction DT, and faces the third rear surface 134 in the thickness direction DT. The fourth rear surface 144 is a surface of the fourth substrate 140 on the other side in the thickness direction DT, and is a surface of the fourth substrate 140 opposite to the fourth front surface 142.

The fifth substrate 150 has a fifth front surface 152 and a fifth rear surface 154. The fifth front surface 152 is a surface of the fifth substrate 150 on one side in the thickness direction DT, and faces the fourth rear surface 144 in the thickness direction DT. The fifth rear surface 154 is a surface of the fifth substrate 150 on the other side in the thickness direction DT, and is a surface of the fifth substrate 150 opposite to the fifth front surface 152.

The first reactor 201 and the second reactor 202 are formed of copper or the like. As illustrated in FIGS. 3 and 4, the first reactor 201 and the second reactor 202 are formed inside the multilayer substrate 100. The first reactor 201 and the second reactor 202 may be formed on the multilayer substrate 100, for example, on the first front surface 112 and the fifth rear surface 154.

The transformer 300 includes a primary winding 301 and a secondary winding 302. The primary winding 301 is patterned with copper or the like. Furthermore, as illustrated in FIG. 6, the primary winding 301 includes a primary-side first winding portion 3011 and a primary-side second winding portion 3012.

As illustrated in FIG. 7, the primary-side first winding portion 3011 is formed in a spiral shape extending on a plane orthogonal to the thickness direction DT. The primary-side first winding portion 3011 is disposed on the first front surface 112. The turns of the primary-side first winding portion 3011 are set to, for example, 4.

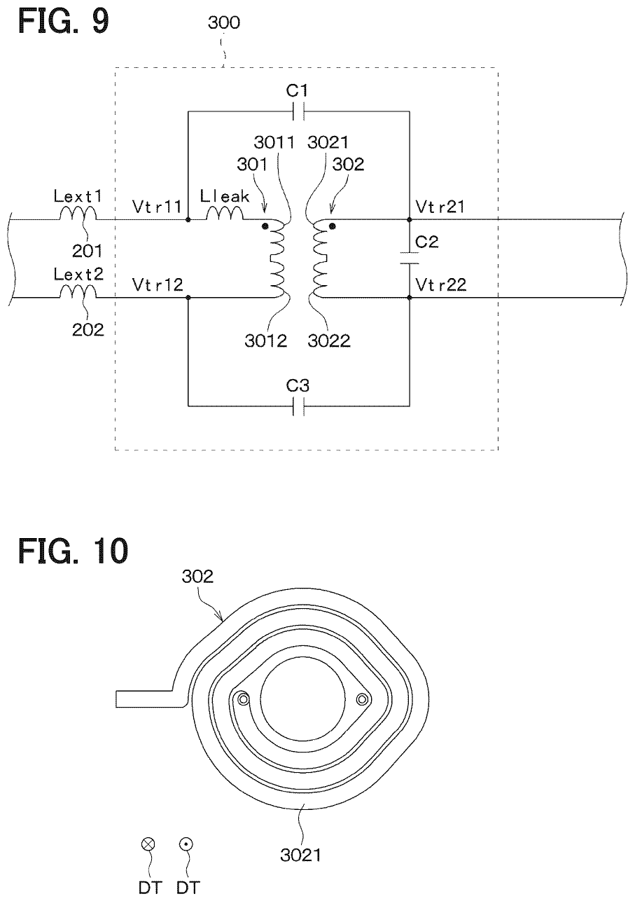

As illustrated in FIG. 8, the primary-side second winding portion 3012 is formed in a spiral shape extending on a plane orthogonal to the thickness direction DT. The winding direction of the primary-side second winding portion 3012 differs from the winding direction of the primary-side first winding portion 3011. Moreover, the primary-side second winding portion 3012 is disposed on the fifth rear surface 154. The turns of the primary-side second winding portion 3012 are set to, for example, 4. As illustrated in FIG. 9, the primary-side second winding portion 3012 is connected in series with the primary-side first winding portion 3011 through a via. Therefore, the turns of the primary winding 301 are set to 8 here.

Returning to FIG. 6, the primary-side first winding portion 3011 and the primary-side second winding portion 3012 are not disposed on the third front surface 132 and the third rear surface 134. Thus, the primary winding 301 is not disposed on the third substrate 130.

The secondary winding 302 is patterned with copper or the like. Furthermore, the secondary winding 302 includes a secondary-side first winding portion 3021 and a secondary-side second winding portion 3022.

As illustrated in FIG. 10, the secondary-side first winding portion 3021 is formed in a spiral shape extending on a plane orthogonal to the thickness direction DT. The winding direction of the secondary-side first winding portion 3021 is set to be identical to the winding direction of the primary-side first winding portion 3011. The secondary-side first winding portion 3021 is disposed on the first rear surface 114 and the second front surface 122. The turns of the secondary-side first winding portion 3021 are set to, for example, 3.

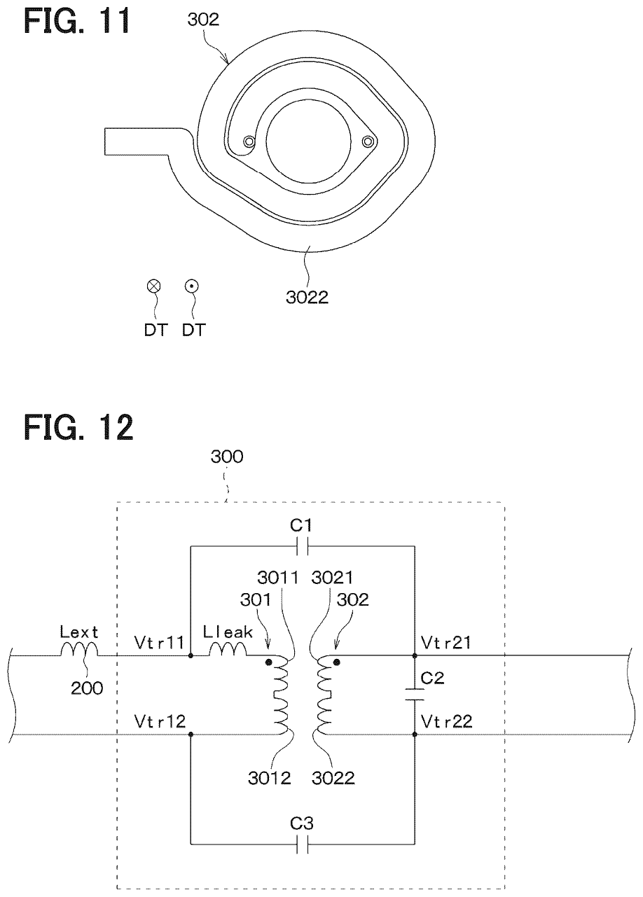

As illustrated in FIG. 11, the secondary-side second winding portion 3022 is formed in a spiral shape extending on a plane orthogonal to the thickness direction DT. The winding direction of the secondary-side second winding portion 3022 differs from the winding direction of the secondary-side first winding portion 3021. Since the winding direction of the secondary-side first winding portion 3021 is set to be identical to the winding direction of the primary-side first winding portion 3011, the winding direction of the secondary-side second winding portion 3022 differs from the winding direction of the primary-side first winding portion 3011 and is set to be identical to the winding direction of the primary-side second winding portion 3012. Furthermore, the secondary-side second winding portion 3022 is disposed on the fourth rear surface 144 and the fifth front surface 152. The turns of the secondary-side second winding portion 3022 are set to, for example, 2. As illustrated in FIG. 9, the secondary-side second winding portion 3022 is connected in series with the secondary-side first winding portion 3021 through a via. Therefore, the turns of the secondary winding 302 are set to 5 here.

Returning to FIG. 6, the secondary-side first winding portion 3021 and the secondary-side second winding portion 3022 are not disposed on the third front surface 132 and the third rear surface 134. Thus, the secondary winding 302 is not disposed on the third substrate 130. Moreover, the third front surface 132 faces the secondary-side first winding portion 3021 in the thickness direction DT. The third rear surface 134 faces the secondary-side second winding portion 3022 in the thickness direction DT.

As illustrated in FIG. 9, the one end of the primary winding 301 corresponds to the end of the primary-side first winding portion 3011 opposite to the primary-side second winding portion 3012. The other end of the primary winding 301 corresponds to the end of the primary-side second winding portion 3012 opposite to the primary-side first winding portion 3011.

The end of the primary-side first winding portion 3011 opposite to the primary-side second winding portion 3012 is connected to the other end of the first reactor 201 through a via and a wiring layer (not illustrated). The end of the primary-side second winding portion 3012 opposite to the primary-side first winding portion 3011 is connected to the other end of the second reactor 202 through a via and a wiring layer (not illustrated).

Here, the inductance of the first reactor 201 is defined as Lext1. The inductance of the second reactor 202 is defined as Lext2. The leakage inductance of the transformer 300 is defined as Lleak.

The first reactor 201, the second reactor 202, and the transformer 300 are preferably formed to satisfy the following relational expression (1-1).

$$Lext = Lext 1 + Lext 2 ; Lext / Lleak \geq 0.5 \qquad ( 1 ‐ 1 )$$

The first reactor 201 and the second reactor 202 are preferably formed to satisfy the following relational expression (1-2). x is a variable. Here, x is defined as a ratio of Lext1 to the sum of Lext1 and Lext2, and corresponds to a value related to the inductance of the first reactor 201 and the inductance of the second reactor 202.

$$Lext = Lext 1 + Lext 2 ; Lext 1 = x \times Lext ; \qquad ( 1 ‐ 2 )$$

$$Lext 2 = ( 1 - x ) \times Lext ; 0.3 \leq x \leq 0.7$$

As illustrated in FIGS. 6 and 9, the first winding capacitance C1 is a winding capacitance between the primary-side first winding portion 3011 and the secondary-side first winding portion 3021. The second winding capacitance C2 is a winding capacitance between the secondary-side first winding portion 3021 and the secondary-side second winding portion 3022. The third winding capacitance C3 is a winding capacitance between the primary-side second winding portion 3012 and the secondary-side second winding portion 3022.

The multilayer substrate 100 of the first embodiment is configured as described above. Next, a description will be given of suppression of a change in voltage at the transformer end by the multilayer substrate 100 according to the present embodiment.

Here, as a comparative example, as illustrated in FIG. 12, the multilayer substrate 100 is assumed to include one reactor 200 instead of the first reactor 201 and the second reactor 202, as in the switching power supply apparatus described in Patent Literature 1. The reactor 200 corresponds to the first reactor 201 when x is 1. Therefore, one end of the reactor 200 is connected between the first switching element Q1 and the second switching element Q2. The other end of the reactor 200 is connected to one end of the primary winding 301, here, the end of the primary-side first winding portion 3011 opposite to the primary-side second winding portion 3012. The inductance of the reactor 200 is Lext and corresponds to Lext1+Lext2.

Furthermore, an amount of change in Va is defined as ΔV1. The difference between the on and off phases of the first switching element Q1 and the fourth switching element Q4 and the on and off phases of the second switching element Q2 and the third switching element Q3 is set to 180°. Thus, the amount of change in Vb is −ΔV1. In addition, an amount of change in Vc is defined as ΔV2. The difference between the on and off phases of the fifth switching element Q5 and the eighth switching element Q8 and the on and off phases of the sixth switching element Q6 and the seventh switching element Q7 is set to 180°. Thus, the amount of change in Vd is −ΔV2.

Moreover, as illustrated in FIGS. 9 and 12, the voltage at one end of the primary winding 301 corresponding to the transformer end, here, the end of the primary-side first winding portion 3011 opposite to the primary-side second winding portion 3012, is defined as Vtr11. A change in Vtr11 is defined as ΔVtr11. In addition, the voltage at the other end of the primary winding 301 corresponding to the transformer end, here, the end of the primary-side second winding portion 3012 opposite to the primary-side first winding portion 3011, is defined as Vtr12. A change in Vtr12 is defined as ΔVtr12.

In the comparative example, ΔVtr11 is expressed by the following relational expression (REF-1). ΔVtr12 is expressed by the following relational expression (REF-2). As described above, N is a ratio of the turns of the secondary winding 302 to the turns of the primary winding 301.

$$Δ Vtr 11 = ( Δ V 1 - 2 \times N \times Δ V 2 + Δ V 1 ) \times \frac{Lleak}{Lext + Lleak} + 2 \times N \times Δ V 2 - Δ V 1 \qquad ( REF - 1 )$$

$$Δ Vtr 12 = - Δ V 1 \qquad ( Ref - 2 )$$

The on/off operation of each switching element at time T2, time T4, or time T6 is referred to as primary-side switching operation SW1. Therefore, in the primary- side switching operation SW1, the first switching element Q1 and the fourth switching element Q4 are turned on from off. The second switching element Q2 and the third switching element Q3 are turned off from on. The fifth switching element Q5 and the eighth switching element Q8 remain off. The sixth switching element Q6 and the seventh switching element Q7 remain on. Alternatively, the first switching element Q1 and the fourth switching element Q4 are turned off from on. The second switching element Q2 and the third switching element Q3 are turned on from off. The fifth switching element Q5 and the eighth switching element Q8 remain on. The sixth switching element Q6 and the seventh switching element Q7 remain off.

In the comparative example, it is assumed that the primary-side switching operation SW1 has been performed. At this time, since Vc and Vd remain unchanged, ΔV2 is 0. Therefore, at this time, ΔVtr11 is expressed by the following relational expression (REF-3). ΔVtr12 is expressed by the following relational expression (REF-4).

$$\begin{matrix}Δ Vtr 11 = ( Δ V 1 + Δ V 1 ) \times \frac{Lleak}{Lext + Lleak} - Δ V 1 \\ = Δ V 1 \times \frac{Lleak - Lext}{Lext + Lleak}\end{matrix} \qquad ( REF - 3 )$$

$$Δ Vtr 12 = - Δ V 1 \qquad ( REF - 4 )$$

Here, the on/off operation of each switching element at time T1, time T3, time T5, or time T7 is referred to as secondary-side switching operation SW2. Thus, in the secondary-side switching operation SW2, the first switching element Q1 and the fourth switching element Q4 remain on. The second switching element Q2 and the third switching element Q3 remain off. The fifth switching element Q5 and the eighth switching element Q8 are turned on from off. The sixth switching element Q6 and the seventh switching element Q7 are turned off from on. Alternatively, the first switching element Q1 and the fourth switching element Q4 remain off. The second switching element Q2 and the third switching element Q3 remain on. The fifth switching element Q5 and the eighth switching element Q8 are turned off from on. The sixth switching element Q6 and the seventh switching element Q7 are turned on from off.

In the comparative example, it is assumed that the secondary-side switching operation SW2 has been performed. At this time, since Va and Vb remain unchanged, ΔV1 is 0. Therefore, at this time, ΔVtr11 is expressed by the following relational expression (REF-5). ΔVtr12 is expressed by the following relational expression (REF-6).

$$\begin{matrix}Δ Vtr 11 = - 2 \times N \times Δ V 2 \times \frac{Lleak}{Lext + Lleak} + 2 \times N \times Δ V 2 \\ = 2 \times N \times Δ V 2 \times \frac{Lext}{Lext + Lleak}\end{matrix} \qquad ( REF - 5 )$$

$$Δ Vtr 12 = 0 \qquad ( REF - 6 )$$

In contrast, in the multilayer substrate 100 of the present embodiment, ΔVtr11 is expressed by the following relational expression (1-3). ΔVtr12 is expressed by the following relational expression (1-4). x is a variable as described above.

$$Δ Vtr 11 = ( Δ V 1 - 2 \times N \times Δ V 2 + Δ V 1 ) \times \frac{Lleak + ( 1 - x ) \times Lext}{Lext + Lleak} + 2 \times N \times Δ V 2 - Δ V 1 \qquad ( 1 - 3 )$$

$$Δ Vtr 12 = ( Δ V 1 - 2 \times N \times Δ V 2 + Δ V 1 ) \times \frac{( 1 - x ) \times Lext}{Lext + Lleak} - Δ V 1 \qquad ( 1 - 4 )$$

Here, it is assumed that the primary-side switching operation SW1 has been performed in the multilayer substrate 100. At this time, since Vc and Vd remain unchanged, ΔV2 is 0. Therefore, at this time, ΔVtr11 is expressed by the following relational expression (1-5). ΔVtr12 is expressed by the following relational expression (1-6).

$$\begin{matrix}Δ Vtr 11 = ( Δ V 1 + Δ V 1 ) \times \frac{Lleak + ( 1 - x ) \times Lext}{Lext + Lleak} - Δ V 1 \\ = Δ V 1 \times \frac{Lleak + ( 1 - 2 \times x ) \times Lext}{Lext + Lleak}\end{matrix} \qquad ( 1 - 5 )$$

$$\begin{matrix}Δ Vtr 12 = ( Δ V 1 + Δ V 1 ) \times \frac{( 1 - x ) \times Lext}{Lext + Lleak} - Δ V 1 \\ = Δ V 1 \times \frac{( 1 - 2 \times x ) \times Lext - Lleak}{Lext + Lleak}\end{matrix} \qquad ( 1 - 6 )$$

It is assumed that the secondary-side switching operation SW2 has been performed in the multilayer substrate 100. At this time, since Va and Vb remain unchanged, ΔV1 is 0. Therefore, at this time, ΔVtr11 is expressed by the following relational expression (1-7). ΔVtr12 is expressed by the following relational expression (1-8).

$$\begin{matrix}Δ Vtr 11 = - 2 \times N \times Δ V 2 \times \frac{Lleak + ( 1 - x ) \times Lext}{Lext + Lleak} + 2 \times N \times Δ V 2 \\ = N \times Δ V 2 \times \frac{2 \times x \times Lext}{Lext + Lleak}\end{matrix} \qquad ( 1 - 7 )$$

$$\begin{matrix}Δ Vtr 12 = - 2 \times N \times Δ V 2 \times \frac{( 1 - x ) \times Lext}{Lext + Lleak} \\ = - N \times Δ V 2 \times \frac{2 \times ( 1 - x ) \times Lext}{Lext + Lleak}\end{matrix} \qquad ( 1 - 8 )$$

Comparing the above relational expression (REF-5) with the above relational expression (1-7), ΔVtr11 of the multilayer substrate 100 in the present embodiment is smaller than that in the comparative example by the value related to x and ΔV2.

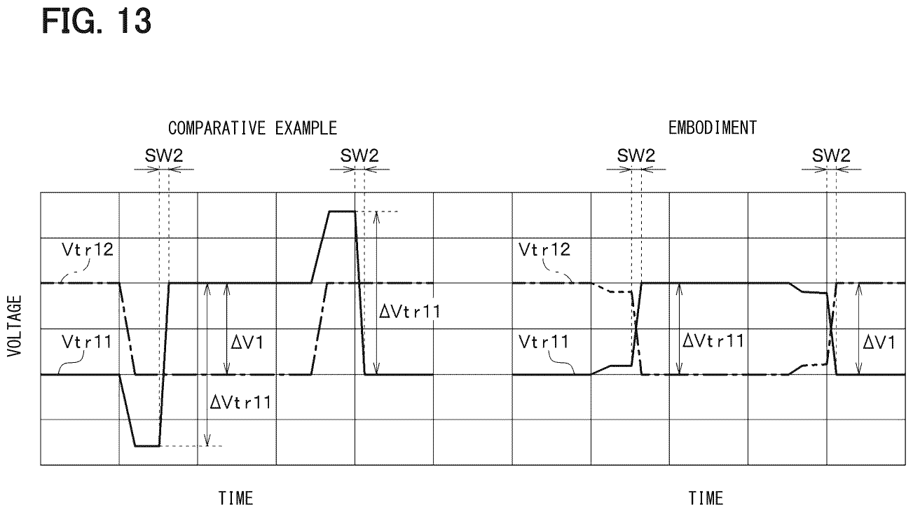

Therefore, as illustrated in FIG. 13, when the secondary-side switching operation SW2 is performed, ΔVtr11 of the multilayer substrate 100 in the present embodiment is smaller than ΔVtr11 in the comparative example. Thus, the multilayer substrate 100 suppresses a change in voltage at the transformer end. Suppression of the change in voltage at the transformer end prevents, for example, the voltage of the transformer 300 from exceeding the withstand voltage of the transformer 300. Therefore, damage to the transformer 300 is suppressed. FIG. 13 is a diagram illustrating temporal changes in Vtr11 and Vtr12 of the multilayer substrate 100 in the comparative example and the present embodiment during operation of the DAB converter.

Furthermore, the multilayer substrate 100 of the first embodiment also achieves the following effects.

Here, as illustrated in FIGS. 9 and 12, the voltage at one end of the secondary winding 302 corresponding to the transformer end, here, the end of the secondary-side first winding portion 3021 opposite to the secondary-side second winding portion 3022, is defined as Vtr21. In addition, the voltage at the other end of the secondary winding 302 corresponding to the transformer end, here, the end of the secondary-side second winding portion 3022 opposite to the primary-side second winding portion 3012, is defined as Vtr22.

Moreover, in the comparative example, it is assumed that the primary-side switching operation SW1 has been performed. At this time, Δ(Vtr11−Vtr12), which is the amount of change in Vtr11−Vtr12, is expressed by the following relational expression (REF-7). Δ(Vtr21−Vtr22), which is the amount of change in Vtr21−Vtr22, is expressed by the following relational expression (REF-8). Δ(Vtr11−Vtr21), which is the amount of change in Vtr11−Vtr21, is expressed by the following relational expression (REF-9). Δ(Vtr11−Vtr22), which is the amount of change in Vtr11−Vtr22, is expressed by the following relational expression (REF-10). Δ(Vtr12−Vtr21), which is the amount of change in Vtr12−Vtr21, is expressed by the following relational expression (REF-11). Δ(Vtr12−Vtr22), which is the amount of change in Vtr12−Vtr22, is expressed by the following relational expression (REF-12).

$$Δ ( Vtr 11 - Vtr 12 ) = Δ V 1 \times \frac{2 \times Lleak}{Lext + Lleak} \qquad ( REF - 7 )$$

$$Δ ( Vtr 21 - Vtr 22 ) = 0 \qquad ( REF - 8 )$$

$$Δ ( Vtr 11 - Vtr 12 ) = Δ V 1 \times \frac{Lleak - Lext}{Lext + Lleak} - Δ V 2 \qquad ( REF - 9 )$$

$$Δ ( Vtr 11 - Vtr 22 ) = Δ V 1 \times \frac{Lleak - Lext}{Lext + Lleak} + Δ V 2 \qquad ( REF - 10 )$$

$$Δ ( Vtr 12 - Vtr 21 ) = - Δ V 1 - Δ V 2 \qquad ( REF - 11 )$$

$$Δ ( Vtr 12 - Vtr 22 ) = - Δ V 1 + Δ V 2 \qquad ( REF - 12 )$$

In the comparative example, it is assumed that the secondary-side switching operation SW2 has been performed. At this time, Δ(Vtr11−Vtr12) is expressed by the following relational expression (REF-13). Δ(Vtr21−Vtr22) is expressed by the following relational expression (REF-14). Δ(Vtr11−Vtr21) is expressed by the following relational expression (REF-15). Δ(Vtr11−Vtr22) is expressed by the following relational expression (REF-16). Δ(Vtr12−Vtr21) is expressed by the following relational expression (REF-17). Δ(Vtr12−Vtr22) is expressed by the following relational expression (REF-18).

$$Δ ( Vtr 11 - Vtr 12 ) = 2 \times N \times Δ V 2 \times \frac{Lext}{Lext + Lleak} \qquad ( REF - 13 )$$

$$Δ ( Vtr 21 - Vtr 22 ) = 2 \times Δ V 2 \qquad ( REF - 14 )$$

$$Δ ( Vtr 11 - Vtr 21 ) = 2 \times N \times Δ V 2 \times \frac{Lext}{Lext + Lleak} - Δ V 2 \qquad ( REF - 15 )$$

$$Δ ( Vtr 11 - Vtr 22 ) = 2 \times N \times Δ V 2 \times \frac{Lext}{Lext + Lleak} + Δ V 2 \qquad ( REF - 16 )$$

$$Δ ( Vtr 12 - Vtr 21 ) = 0 - Δ V 2 \qquad ( REF - 17 )$$

$$Δ ( Vtr 12 - Vtr 22 ) = 0 + Δ V 2 \qquad ( REF - 18 )$$

In contrast, in the multilayer substrate 100 of the present embodiment, when the primary-side switching operation SW1 is performed, Δ(Vtr11−Vtr12) is expressed by the following relational expression (1-9). Δ(Vtr21−Vtr22) is expressed by the following relational expression (1-10). Δ(Vtr11−Vtr21) is expressed by the following relational expression (1-11). Δ(Vtr11−Vtr22) is expressed by the following relational expression (1-12). Δ(Vtr12−Vtr21) is expressed by the following relational expression (1-13). Δ(Vtr12−Vtr22) is expressed by the following relational expression (1-14).

$$Δ ( Vtr 11 - Vtr 12 ) = Δ V 1 \times \frac{2 \times Lleak}{Lext + Lleak} - Δ V 2 \qquad ( 1 - 9 )$$

$$Δ ( Vtr 21 - Vtr 22 ) = 0 \qquad ( 1 - 10 )$$

$$Δ ( Vtr 11 - Vtr 21 ) = Δ V 1 \times \frac{Lleak + ( 1 - 2 \times x ) \times Lext}{Lext + Lleak} - Δ V 2 \qquad ( 1 - 11 )$$

$$Δ ( Vtr 11 - Vtr 22 ) = Δ V 1 \times \frac{Lleak + ( 1 - 2 \times x ) \times Lext}{Lext + Lleak} - Δ V 2 \qquad ( 1 - 12 )$$

$$Δ ( Vtr 12 - Vtr 21 ) - Δ V 1 \times \frac{( 1 - 2 \times x ) \times Lext - Lleak}{Lext + Lleak} - Δ V 2 \qquad ( 1 - 13 )$$

$$Δ ( Vtr 12 - Vtr 22 ) = Δ V 1 \times \frac{( 1 - 2 \times x ) \times Lext - Lleak}{Lext + Lleak} + Δ V 2 \qquad ( 1 - 14 )$$

Furthermore, in the multilayer substrate 100, when the secondary-side switching operation SW2 is performed, Δ(Vtr11−Vtr12) is expressed by the following relational expression (1-15). Δ(Vtr21−Vtr22) is expressed by the following relational expression (1-16). Δ(Vtr11−Vtr21) is expressed by the following relational expression (1-17). Δ(Vtr11−Vtr22) is expressed by the following relational expression (1-18). Δ(Vtr12−Vtr21) is expressed by the following relational expression (1-19). Δ(Vtr12−Vtr22) is expressed by the following relational expression (1-20).

$$Δ ( Vtr 11 - Vtr 12 ) = 2 \times N \times Δ V 2 \times \frac{Lext}{Lext + Lleak} \qquad ( 1 - 15 )$$

$$Δ ( Vtr 21 - Vtr 22 ) = 2 \times Δ V 2 \qquad ( 1 - 16 )$$

$$Δ ( Vtr 11 - Vtr 21 ) = N \times Δ V 2 \times \frac{2 \times x \times Lext}{Lext + Lleak} - Δ V 2 \qquad ( 1 - 17 )$$

$$Δ ( Vtr 11 - Vtr 22 ) = N \times Δ V 2 \times \frac{2 \times x \times Lext}{Lext + Lleak} + Δ V 2 \qquad ( 1 - 18 )$$

$$Δ ( Vtr 12 - Vtr 21 ) = - N \times Δ V 2 \times \frac{2 \times ( 1 - x ) \times Lext}{Lext + Lleak} - Δ V 2 \qquad ( 1 - 19 )$$

$$Δ ( Vtr 12 - Vtr 22 ) = - N \times Δ V 2 \times \frac{2 \times ( 1 - x ) \times Lext}{Lext + Lleak} + Δ V 2 \qquad ( 1 - 20 )$$

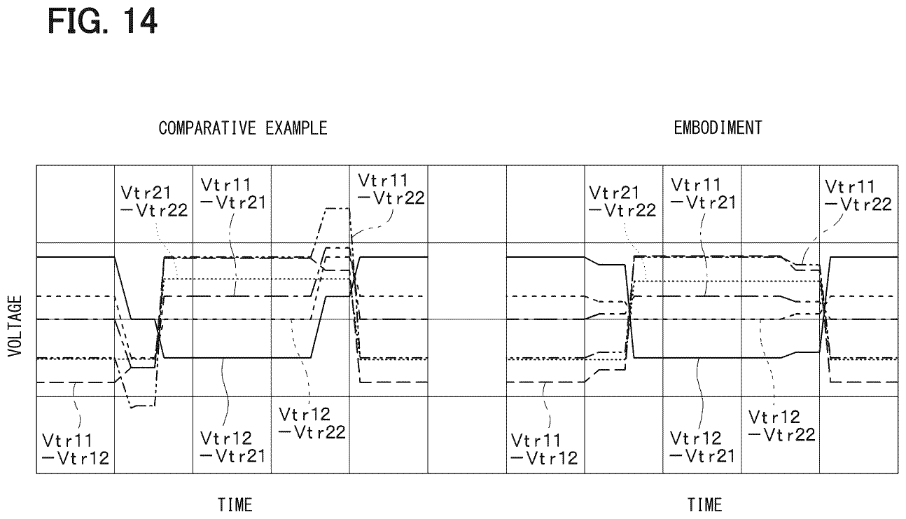

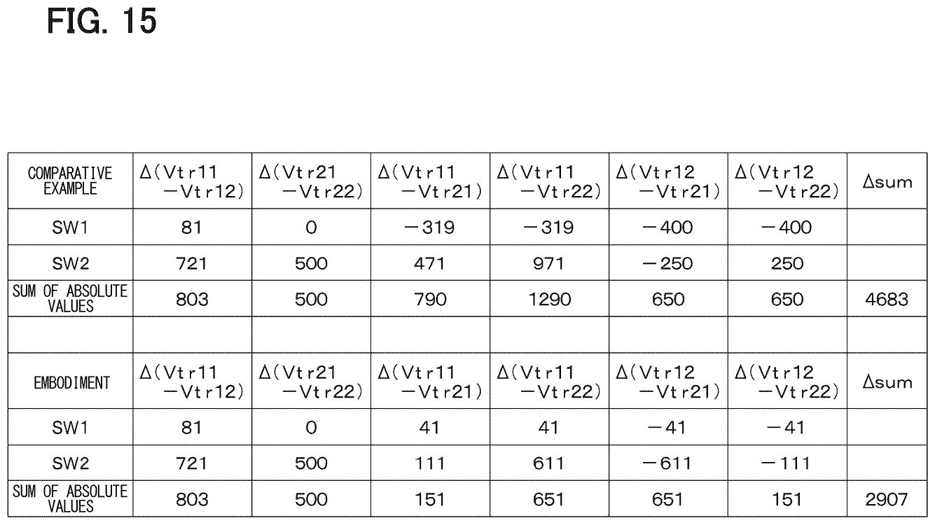

When temporal changes in the respective voltage differences of the multilayer substrate 100 in the comparative example and the present embodiment during operation of the DAB converter are plotted, the results are as shown in FIG. 14. The amounts of change in the respective voltage differences in the comparative example and the present embodiment when the primary-side switching operation SW1 and the secondary-side switching operation SW2 are performed are as illustrated in FIG. 15.

Comparing the above relational expressions (REF-7) to (REF-18) with the above relational expressions (1-9) to (1-20), there is no difference in Δ(Vtr11−Vtr12) and Δ(Vtr21−Vtr22). In contrast, Δ(Vtr11−Vtr21), Δ(Vtr11−Vtr22), Δ(Vtr12−Vtr21), and Δ(Vtr12−Vtr22) of the present embodiment are smaller than those of the comparative example by values related to x and ΔV2. Thus, while Δsum in the comparative example was 4683 V, Δsum in the present embodiment was 2907 V. Therefore, Δsum of the present embodiment is 38% smaller than Δsum of the comparative example. Δsum is a sum of absolute values of voltage differences in the primary-side switching operation SW1 and the secondary-side switching operation SW2.

Here, when the voltage applied to the winding capacitance changes, a current corresponding to the amount of change in voltage flows through the winding capacitance. The current flowing through the winding capacitance decreases as the amount of change in voltage applied to the winding capacitance decreases.

In addition, since the loss of the ER core 103 is a loss due to a change in the magnetic flux of the ER core 103, the loss increases as the current flowing through the transformer 300 increases. The current flowing through the transformer 300 includes a main current flowing through the primary winding 301 and the secondary winding 302, and a current flowing through the winding capacitance. The current flowing through the winding capacitance flows in the same manner as the main current flowing through the primary winding 301 and the secondary winding 302. Therefore, the loss of the ER core 103 decreases as the current flowing through the winding capacitance decreases.

Furthermore, in the multilayer substrate 100 of the present embodiment, Δ(Vtr11−Vtr21) decreases as described above. As a result, when there is a winding capacitance between the one end of the primary winding 301 and the one end of the secondary winding 302, the current flowing through the winding capacitance decreases. In addition, Δ(Vtr11−Vtr22) decreases. Thus, when there is a winding capacitance between the one end of the primary winding 301 and the other end of the secondary winding 302, the current flowing through the winding capacitance decreases. Furthermore, Δ(Vtr12−Vtr21) decreases. Thus, when there is a winding capacitance between the other end of the primary winding 301 and the one end of the secondary winding 302, the current flowing through the winding capacitance decreases. In addition, Δ(Vtr12−Vtr22) decreases. Thus, when there is a winding capacitance between the other end of the primary winding 301 and the other end of the secondary winding 302, the current flowing through the winding capacitance decreases. Accordingly, when the winding capacitance is present, the current flowing through the winding capacitance becomes smaller, resulting in a decrease in loss of the ER core 103.

In the multilayer substrate 100, the first winding capacitance C1 is present between the one end of the primary winding 301 and the one end of the secondary winding 302. The third winding capacitance C3 is present between the other end of the primary winding 301 and the other end of the secondary winding 302.

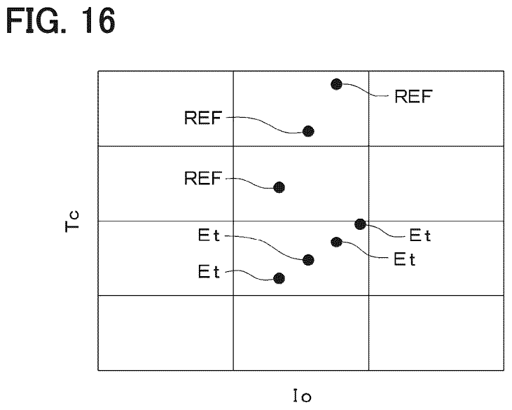

Therefore, the current flowing through the first winding capacitance C1 and the third winding capacitance C3 decreases. As a result, the loss of the ER core 103 is reduced. For this reason, as illustrated in FIG. 16, in the present embodiment, the temperature of the ER core 103 relative to the output current of the DAB converter is lower than that in the comparative example. In FIG. 16, the output current of the DAB converter is indicated as Io. The temperature of the ER core 103 is indicated as Tc. The temperature of the ER core 103 relative to the output current of the DAB converter in the comparative example is indicated as REF. The temperature of the ER core 103 relative to the output current of the DAB converter in the present embodiment is indicated as Et.

The first reactor 201 is connected to the one end of the primary winding 301. The second reactor 202 is connected to the other end of the primary winding 301. The one end of the primary winding 301 corresponds to a first end. The first end is one end of the transformer 300. The other end of the primary winding 301 corresponds to a second end. The second end is the other end of the transformer 300.

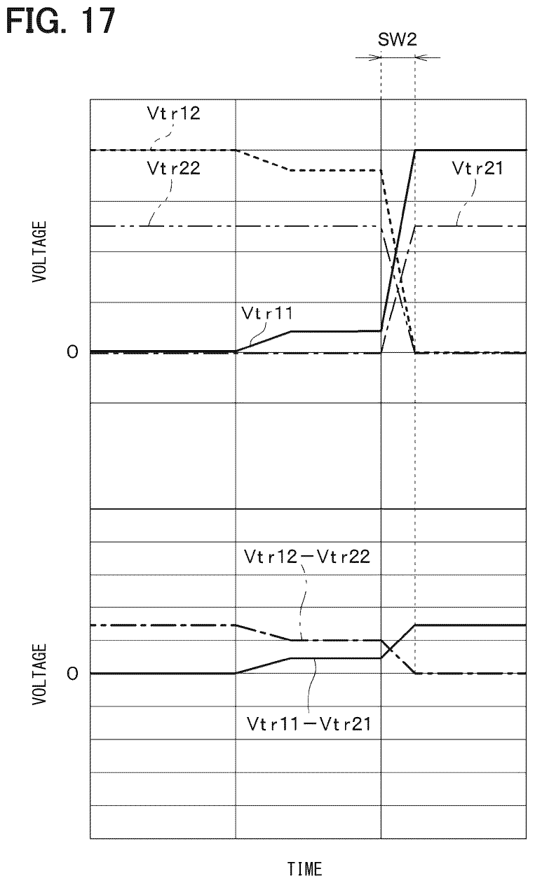

Here, it is assumed that the secondary-side switching operation SW2 has been performed in the multilayer substrate 100. At this time, due to the connection between the first reactor 201 and the second reactor 202, as illustrated in FIG. 17, the timing at which Vtr11 increases and the timing at which Vtr21 increases become the same. Thus, in Δ(Vtr11−Vtr21), the increase in Vtr11 and the increase in Vtr21 cancel each other out. For this reason, Δ(Vtr11−Vtr21) decreases. Therefore, the current flowing through the first winding capacitance C1 decreases. Accordingly, the loss of the ER core 103 is reduced.

In addition, the timing at which Vtr12 decreases and the timing at which Vtr22 decreases become the same. Thus, in Δ(Vtr12−Vtr22), the decrease in Vtr12 and the decrease in Vtr22 cancel each other out. For this reason, Δ(Vtr12−Vtr22) decreases. Therefore, the current flowing through the third winding capacitance C3 decreases. Accordingly, the loss of the ER core 103 is reduced.

The first reactor 201, the second reactor 202, and the transformer 300 are preferably formed to satisfy the above relational expression (1-1).

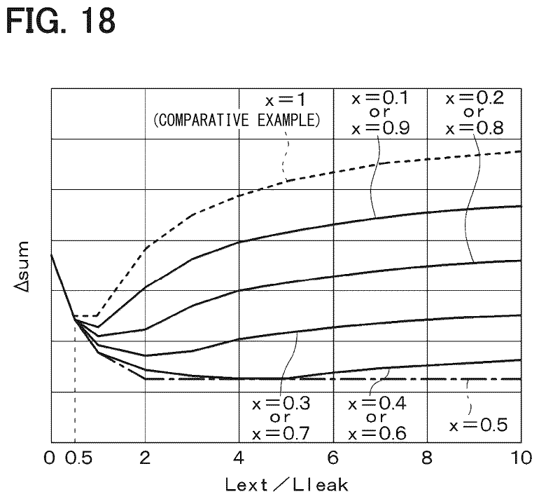

Thus, as illustrated in FIG. 18, Δsum tends to be smaller than that in the comparative example. For this reason, the amount of change in voltage applied to the winding capacitance is reduced. Therefore, the current flowing through the winding capacitance decreases. Accordingly, the loss of the ER core 103 is reduced.

The first reactor 201 and the second reactor 202 are preferably formed to satisfy the above relational expression (1-2).

As a result, as illustrated in FIG. 18, Δsum is smaller than when 0<x<0.3 or 0.7<x<1. For this reason, the amount of change in voltage applied to the winding capacitance is reduced. Therefore, the current flowing through the winding capacitance decreases. Accordingly, the loss of the ER core 103 is reduced.

The third substrate 130 is disposed between the first substrate 110 and the fifth substrate 150. The primary winding 301 and the secondary winding 302 are not disposed on the third substrate 130. The third front surface 132 faces the secondary-side first winding portion 3021 in the thickness direction DT. The third rear surface 134 faces the secondary-side second winding portion 3022 in the thickness direction DT. Furthermore, the winding direction of the secondary-side first winding portion 3021 differs from the winding direction of the secondary-side second winding portion 3022.

As a result, the distance between the secondary-side first winding portion 3021 and the secondary-side second winding portion 3022 becomes longer than in the case where the third substrate 130 is not provided. Thus, the capacitance of the second winding capacitance C2 decreases. Therefore, the current flowing through the second winding capacitance C2 decreases. Accordingly, the loss of the ER core 103 is reduced.

### Second Embodiment

In the second embodiment, the configurations of the first reactor 201 and the second reactor 202 differ from those in the first embodiment. The other configurations are similar to those in the first embodiment.

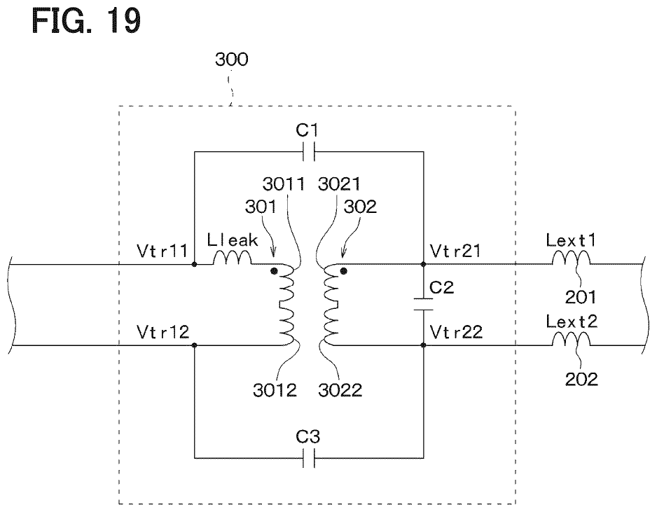

Specifically, as illustrated in FIG. 19, the one end of the first reactor 201 is connected to the one end of the secondary winding 302. Therefore, the one end of the first reactor 201 is connected to the end of the secondary-side first winding portion 3021 opposite to the secondary-side second winding portion 3022. The other end of the first reactor 201 is connected between the fifth switching element Q5 and the sixth switching element Q6.

The one end of the second reactor 202 is connected to the other end of the secondary winding 302. Thus, the one end of the second reactor 202 is connected to the end of the secondary-side second winding portion 3022 opposite to the primary-side second winding portion 3012. The other end of the second reactor 202 is connected between the seventh switching element Q7 and the eighth switching element Q8.

The multilayer substrate 100 of the second embodiment is configured as described above. In the second embodiment, similar effects to those of the first embodiment are also achieved.

### Third Embodiment

In the third embodiment, the configurations of the first reactor 201, the second reactor 202, and the transformer 300 differ from those in the first embodiment. The other configurations are similar to those in the first embodiment.

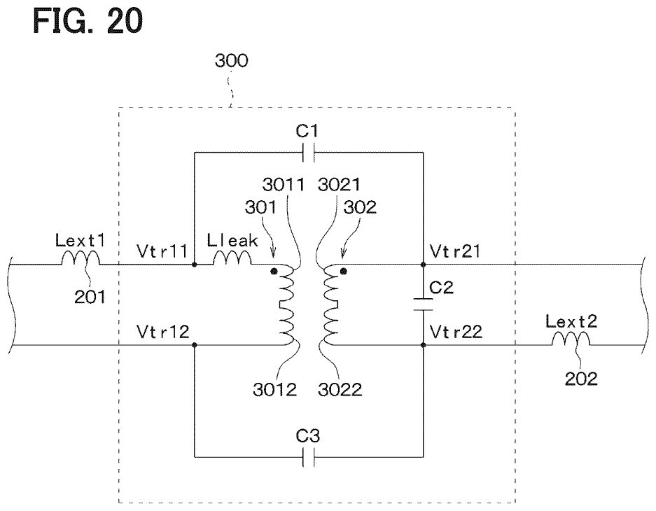

Specifically, as illustrated in FIG. 20, the one end of the second reactor 202 is connected to the other end of the secondary winding 302. Therefore, the one end of the second reactor 202 is connected to the end of the secondary-side second winding portion 3022 opposite to the secondary-side first winding portion 3021. The other end of the second reactor 202 is connected between the seventh switching element Q7 and the eighth switching element Q8. The other end of the secondary winding 302 corresponds to the second end.

Furthermore, the first reactor 201, the second reactor 202, and the transformer 300 are preferably formed to satisfy the following relational expression (2-1).

$$Lext = Lext 1 + Lext 2 \times N \times N ; Lext / Lleak \geq 0.5 \qquad ( 2 - 1 )$$

The first reactor 201 and the second reactor 202 are preferably formed to satisfy the following relational expression (2-2).

$$Lext = Lext 1 + Lext 2 \times N \times N ; \qquad ( 2 - 2 )$$

$$Lext 1 = x \times Lext ; Lext 2 = ( 1 - x ) \times Lext / ( N \times N ) ; 0.3 \leq x \leq 0.7$$

The multilayer substrate 100 of the third embodiment is configured as described above. In the third embodiment, similar effects to those of the first embodiment are also achieved.

### Fourth Embodiment

In the fourth embodiment, the configurations of the first reactor 201 and the second reactor 202 differ from those in the third embodiment. The other configurations are similar to those in the third embodiment.

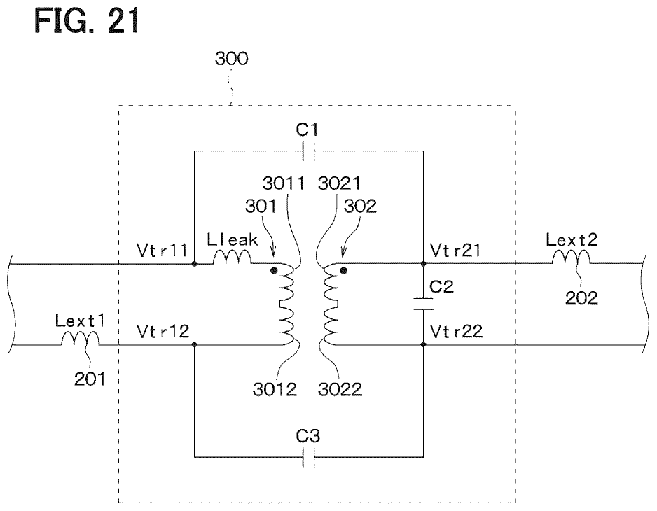

Specifically, as illustrated in FIG. 21, the one end of the first reactor 201 is connected to the other end of the primary winding 301. Therefore, the one end of the first reactor 201 is connected to the end of the primary-side second winding portion 3012 opposite to the primary-side first winding portion 3011. The other end of the first reactor 201 is connected between the third switching element Q3 and the fourth switching element Q4. The other end of the primary winding 301 corresponds to the first end.

The one end of the second reactor 202 is connected to the one end of the secondary winding 302. Thus, the one end of the second reactor 202 is connected to the end of the secondary-side first winding portion 3021 opposite to the secondary-side second winding portion 3022. The other end of the second reactor 202 is connected between the fifth switching element Q5 and the sixth switching element Q6. Furthermore, the one end of the secondary winding 302 corresponds to the second end.

The multilayer substrate 100 of the fourth embodiment is configured as described above. In the fourth embodiment, similar effects to those of the third embodiment are also achieved.

### Fifth Embodiment

In the fifth embodiment, the configuration of the second reactor 202 differs from that in the first embodiment. The other configurations are similar to those in the first embodiment.

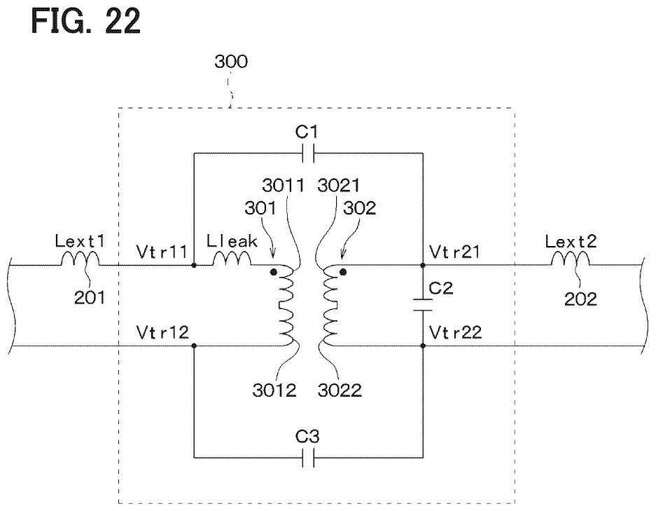

Specifically, as illustrated in FIG. 22, the one end of the second reactor 202 is connected to the one end of the secondary winding 302. Therefore, the one end of the second reactor 202 is connected to the end of the secondary-side first winding portion 3021 opposite to the secondary-side second winding portion 3022. The other end of the second reactor 202 is connected between the fifth switching element Q5 and the sixth switching element Q6.

The multilayer substrate 100 of the fifth embodiment is configured as described above. In the fifth embodiment, similar effects to those of the first embodiment are also achieved.

### Sixth Embodiment

In the sixth embodiment, the configurations of the first reactor 201 and the second reactor 202 differ from those in the fifth embodiment. The other configurations are similar to those in the fifth embodiment.

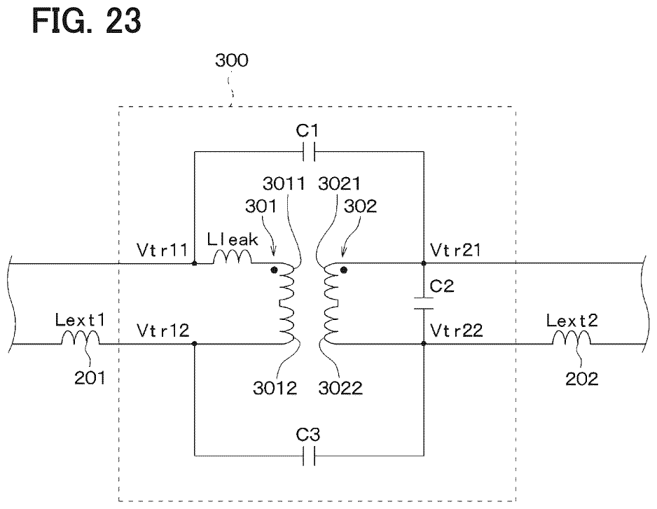

Specifically, as illustrated in FIG. 23, the one end of the first reactor 201 is connected to the other end of the primary winding 301. Therefore, the one end of the first reactor 201 is connected to the end of the primary-side second winding portion 3012 opposite to the primary-side first winding portion 3011. The other end of the first reactor 201 is connected between the third switching element Q3 and the fourth switching element Q4.

The one end of the second reactor 202 is connected to the other end of the secondary winding 302. Thus, the one end of the second reactor 202 is connected to the end of the secondary-side second winding portion 3022 opposite to the primary-side second winding portion 3012. The other end of the second reactor 202 is connected between the seventh switching element Q7 and the eighth switching element Q8.

The multilayer substrate 100 of the sixth embodiment is configured as described above. In the sixth embodiment, similar effects to those of the fifth embodiment are also achieved.

### Seventh Embodiment

In the seventh embodiment, the multilayer substrate 100 includes a third reactor 203 in addition to the first reactor 201 and the second reactor 202. The other configurations are similar to those in the first embodiment.

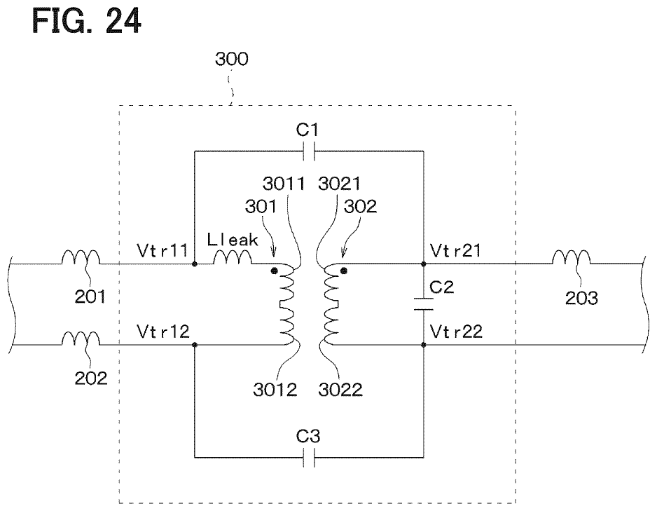

The third reactor 203 is formed of copper or the like inside the multilayer substrate 100 or on the multilayer substrate 100. As illustrated in FIG. 24, one end of the third reactor 203 is connected to the one end of the secondary winding 302. Therefore, the one end of the third reactor 203 is connected to the end of the secondary-side first winding portion 3021 opposite to the secondary-side second winding portion 3022. The other end of the third reactor 203 is connected between the fifth switching element Q5 and the sixth switching element Q6.

The multilayer substrate 100 of the seventh embodiment is configured as described above. In the seventh embodiment, similar effects to those of the first embodiment are also achieved.

### Eighth Embodiment

In the eighth embodiment, the configuration of the third reactor 203 differs from that in the first embodiment. The other configurations are similar to those in the seventh embodiment.

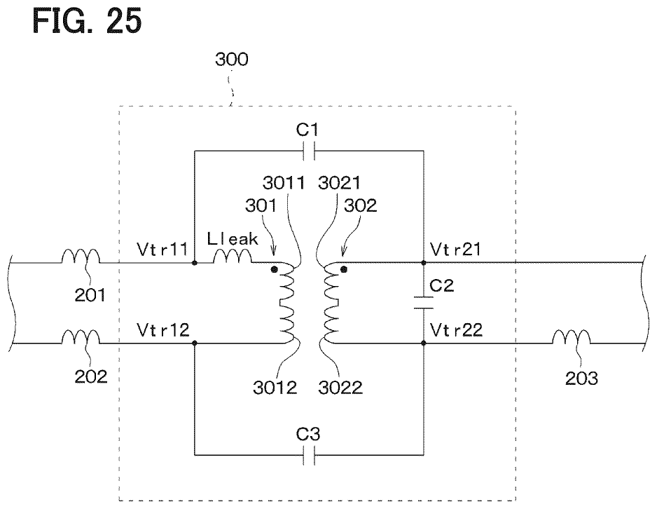

Specifically, as illustrated in FIG. 25, the one end of the third reactor 203 is connected to the other end of the secondary winding 302. Therefore, the one end of the third reactor 203 is connected to the end of the secondary-side second winding portion 3022 opposite to the secondary-side first winding portion 3021. The other end of the third reactor 203 is connected between the seventh switching element Q7 and the eighth switching element Q8.

The multilayer substrate 100 of the eighth embodiment is configured as described above. In the eighth embodiment, similar effects to those of the seventh embodiment are also achieved.

### Ninth Embodiment

In the ninth embodiment, the configuration of the second reactor 202 differs from that in the first embodiment. The other configurations are similar to those in the seventh embodiment.

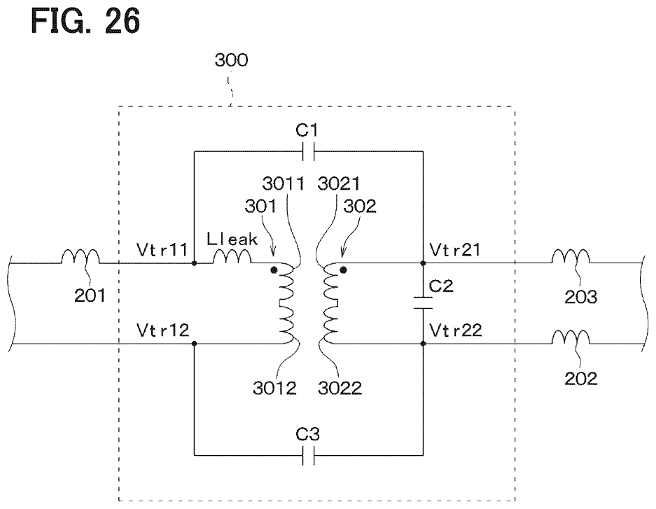

Specifically, as illustrated in FIG. 26, the one end of the second reactor 202 is connected to the other end of the secondary winding 302. Therefore, the one end of the second reactor 202 is connected to the end of the secondary-side second winding portion 3022 opposite to the primary-side second winding portion 3012. The other end of the second reactor 202 is connected between the seventh switching element Q7 and the eighth switching element Q8.

The multilayer substrate 100 of the ninth embodiment is configured as described above. In the ninth embodiment, similar effects to those of the seventh embodiment are also achieved.

### Tenth Embodiment

In the tenth embodiment, the configuration of the first reactor 201 differs from that in the first embodiment. The other configurations are similar to those in the ninth embodiment.

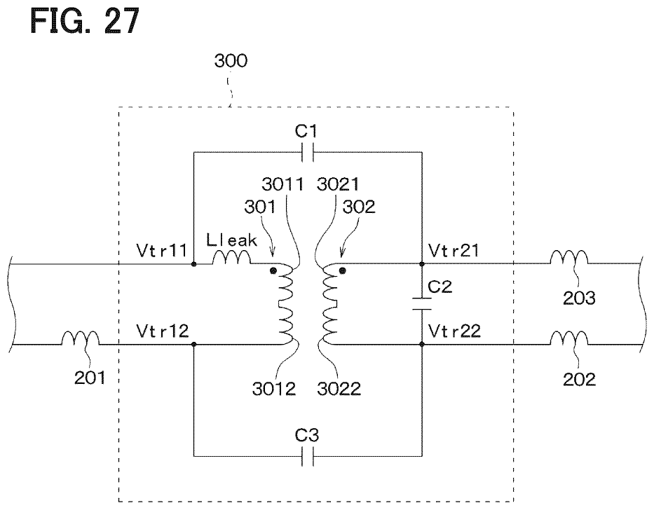

Specifically, as illustrated in FIG. 27, the one end of the first reactor 201 is connected to the other end of the primary winding 301. Therefore, the one end of the first reactor 201 is connected to the end of the primary-side second winding portion 3012 opposite to the primary-side first winding portion 3011. The other end of the first reactor 201 is connected between the third switching element Q3 and the fourth switching element Q4.

The multilayer substrate 100 of the tenth embodiment is configured as described above. In the tenth embodiment, similar effects to those of the ninth embodiment are also achieved.

### Eleventh Embodiment

In the tenth embodiment, the multilayer substrate 100 includes a fourth reactor 204 in addition to the first reactor 201, the second reactor 202, and the third reactor 203. The other configurations are similar to those in the seventh embodiment.

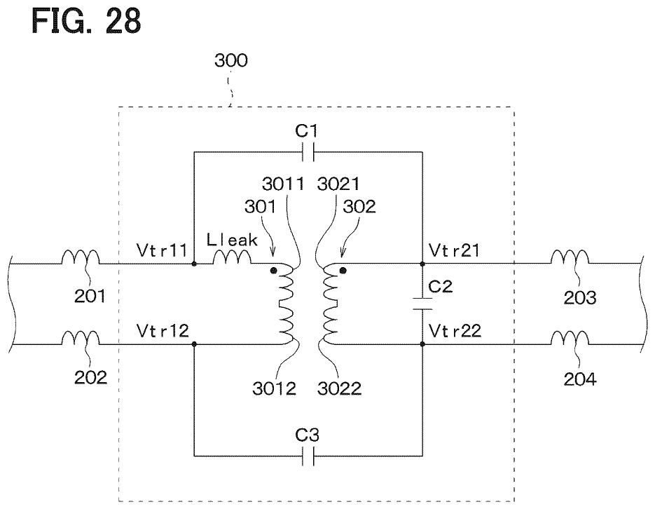

The fourth reactor 204 is formed of copper or the like inside the multilayer substrate 100 or on the multilayer substrate 100. As illustrated in FIG. 28, one end of the fourth reactor 204 is connected to the other end of the secondary winding 302. Therefore, the one end of the fourth reactor 204 is connected to the end of the secondary-side second winding portion 3022 opposite to the primary-side second winding portion 3012. The other end of the fourth reactor 204 is connected between the seventh switching element Q7 and the eighth switching element Q8.

The multilayer substrate 100 of the eleventh embodiment is configured as described above. In the eleventh embodiment, similar effects to those of the seventh embodiment are also achieved.

### Twelfth Embodiment

In the twelfth embodiment, the configuration of the transformer 300 differs from that in the first embodiment. The other configurations are similar to those in the first embodiment.

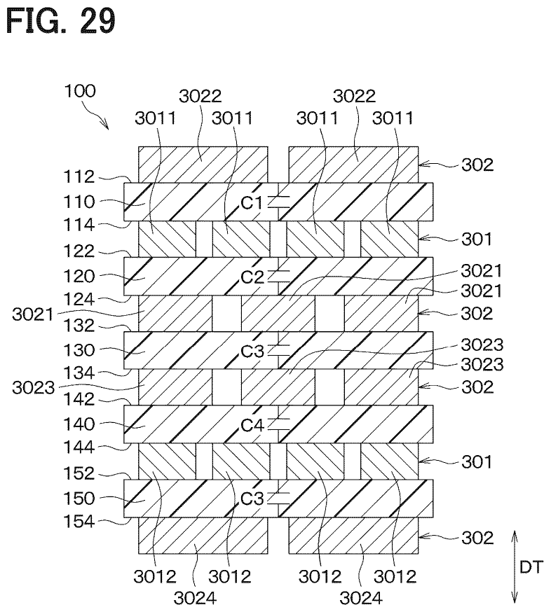

Specifically, as illustrated in FIG. 29, the primary-side first winding portion 3011 is disposed on the first rear surface 114 and the second front surface 122. The primary-side second winding portion 3012 is disposed on the fourth rear surface 144 and the fifth front surface 152.

The secondary-side first winding portion 3021 is disposed on the second rear surface 124 and the third front surface 132. The secondary-side second winding portion 3022 is disposed on the first front surface 112.

The secondary winding 302 includes a secondary-side third winding portion 3023 and a secondary-side fourth winding portion 3024 in addition to the secondary-side first winding portion 3021 and the secondary-side second winding portion 3022.

The secondary-side third winding portion 3023 is disposed on the third rear surface 134 and the fourth front surface 142. The turns of the secondary-side third winding portion 3023 are set to, for example, 3.

The secondary-side fourth winding portion 3024 is disposed on the fifth rear surface 154. The turns of the secondary-side fourth winding portion 3024 are set to, for example, 2.

Furthermore, the secondary-side first winding portion 3021 and the secondary-side third winding portion 3023 are connected in parallel through a via (not illustrated). The secondary-side third winding portion 3023 and the secondary-side fourth winding portion 3024 are connected in series through a via (not illustrated). The secondary-side second winding portion 3022 and the secondary-side fourth winding portion 3024 are connected in parallel through a via (not illustrated).

The first winding capacitance C1 is a winding capacitance between the primary-side first winding portion 3011 and the secondary-side second winding portion 3022. The second winding capacitance C2 is a winding capacitance between the primary-side first winding portion 3011 and the secondary-side first winding portion 3021. The third winding capacitance C3 is a winding capacitance between the secondary-side first winding portion 3021 and the secondary-side third winding portion 3023.

Moreover, the transformer 300 has a fourth winding capacitance C4 and a fifth winding capacitance C5 in addition to the first winding capacitance C1, the second winding capacitance C2, and the third winding capacitance C3.

The fourth winding capacitance C4 is a winding capacitance between the primary-side second winding portion 3012 and the secondary-side third winding portion 3023. The fifth winding capacitance C5 is a winding capacitance between the primary-side second winding portion 3012 and the secondary-side fourth winding portion 3024.

The multilayer substrate 100 of the twelfth embodiment is configured as described above. In the twelfth embodiment, similar effects to those of the first embodiment are also achieved.

### Thirteenth Embodiment

In the thirteenth embodiment, the configuration of the transformer 300 differs from that in the twelfth embodiment. The other configurations are similar to those in the twelfth embodiment.

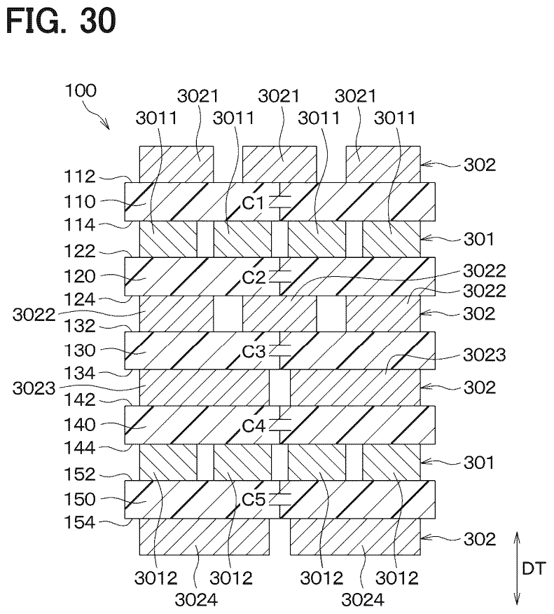

Specifically, as illustrated in FIG. 30, the secondary-side first winding portion 3021 is disposed on the first front surface 112. The turns of the secondary-side first winding portion 3021 are set to, for example, 3.

The secondary-side second winding portion 3022 is disposed on the second rear surface 124 and the third front surface 132. The turns of the secondary-side second winding portion 3022 are set to, for example, 3.

The secondary-side third winding portion 3023 is disposed on the third rear surface 134 and the fourth front surface 142. The turns of the secondary-side third winding portion 3023 are set to, for example, 2.

The secondary-side fourth winding portion 3024 is disposed on the fifth rear surface 154. The turns of the secondary-side fourth winding portion 3024 are set to, for example, 2.

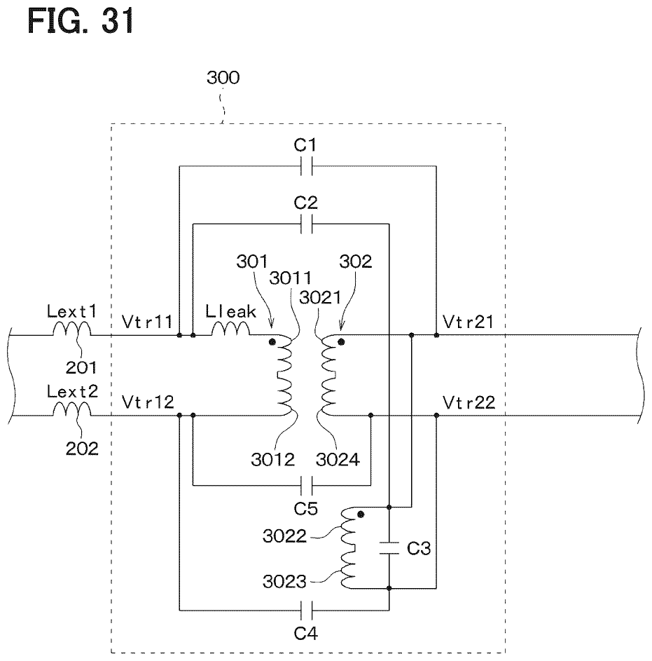

Furthermore, as illustrated in FIG. 31, the secondary-side first winding portion 3021 and the secondary-side second winding portion 3022 are connected in parallel through a via (not illustrated). The secondary-side first winding portion 3021 and the secondary-side fourth winding portion 3024 are connected in series through a via (not illustrated). The secondary-side second winding portion 3022 and the secondary-side third winding portion 3023 are connected in series through a via (not illustrated). The secondary-side third winding portion 3023 and the secondary-side fourth winding portion 3024 are connected in parallel through a via (not illustrated).

The winding directions of the primary-side first winding portion 3011, the secondary-side first winding portion 3021, and the secondary-side third winding portion 3023 are set to be identical. The winding directions of the primary-side second winding portion 3012, the secondary-side third winding portion 3023, and the secondary-side fourth winding portion 3024 are set to be identical.

Moreover, the secondary-side first winding portion 3021 and the secondary-side second winding portion 3022 are connected between the fifth switching element Q5 and the sixth switching element Q6. The secondary-side third winding portion 3023 and the secondary-side fourth winding portion 3024 are connected between the seventh switching element Q7 and the eighth switching element Q8.

As illustrated in FIGS. 30 and 31, the first winding capacitance C1 is a winding capacitance between the primary-side first winding portion 3011 and the secondary-side first winding portion 3021. The second winding capacitance C2 is a winding capacitance between the primary-side first winding portion 3011 and the secondary-side second winding portion 3022. The third winding capacitance C3 is a winding capacitance between the secondary-side second winding portion 3022 and the secondary-side third winding portion 3023. The fourth winding capacitance C4 is a winding capacitance between the primary-side second winding portion 3012 and the secondary-side third winding portion 3023. The fifth winding capacitance C5 is a winding capacitance between the primary-side second winding portion 3012 and the secondary-side fourth winding portion 3024.

The multilayer substrate 100 of the thirteenth embodiment is configured as described above. In the thirteenth embodiment, similar effects to those of the twelfth embodiment are also achieved. Furthermore, the thirteenth embodiment also achieves the following effects.

Here, the polarity of the transformer 300 is set to be the same polarity. Therefore, when a voltage is applied to the primary winding 301, the polarity of the voltage at the one end of the primary winding 301 becomes identical to the polarity of the voltage at the one end of the secondary winding 302. When a voltage is applied to the primary winding 301, the polarity of the voltage at the other end of the primary winding 301 becomes identical to the polarity of the voltage at the other end of the secondary winding 302. When a voltage is applied to the primary winding 301, the polarity of the voltage at the one end of the primary winding 301 is opposite to the polarity of the voltage at the other end of the secondary winding 302.

Therefore, when there is a winding capacitance between the one end of the primary winding 301 and the other end of the secondary winding 302, or between the other end of the primary winding 301 and the one end of the secondary winding 302, a voltage applied to the winding capacitance is a sum of voltages therebetween. Accordingly, at this time, the amount of change in voltage applied to the winding capacitance becomes relatively large.

In contrast, in the thirteenth embodiment, the first winding capacitance C1 and the second winding capacitance C2 are winding capacitances between the one end of the primary winding 301 and the one end of the secondary winding 302.

As a result, voltage applied to each of the first winding capacitance C1 and the second winding capacitance C2 becomes a voltage difference at one end of the primary winding 301 and one end of the secondary winding 302. For this reason, the voltage applied to each of the first winding capacitance C1 and the second winding capacitance C2 becomes relatively small. Therefore, the amount of change in voltage applied to the first winding capacitance C1 and the second winding capacitance C2 becomes relatively small. Thus, the current flowing through the first winding capacitance C1 and the second winding capacitance C2 decreases. As a result, the loss of the ER core 103 is reduced.

The fourth winding capacitance C4 and the fifth winding capacitance C5 are winding capacitances between the other end of the primary winding 301 and the other end of the secondary winding 302.

Accordingly, similarly to the above, since the voltage applied to each of the fourth winding capacitance C4 and the fifth winding capacitance C5 becomes relatively small, the loss of the ER core 103 is reduced.

### Fourteenth Embodiment

In the fourteenth embodiment, the configuration of the transformer 300 differs from that in the first embodiment. The other configurations are similar to those in the first embodiment.

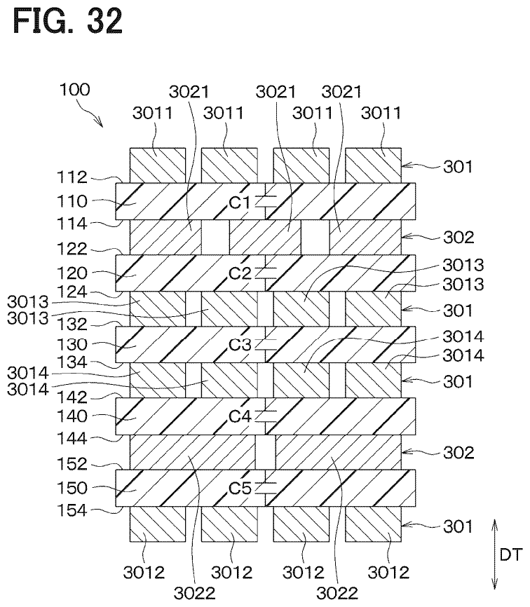

Specifically, as illustrated in FIG. 32, the primary winding 301 includes a primary-side third winding portion 3013 and a primary-side fourth winding portion 3014 in addition to the primary-side first winding portion 3011 and the primary-side second winding portion 3012.

The primary-side third winding portion 3013 is disposed on the second rear surface 124 and the third front surface 132. The turns of the primary-side third winding portion 3013 are set to, for example, 4.

The primary-side fourth winding portion 3014 is disposed on the third rear surface 134 and the fourth front surface 142. The turns of the primary-side fourth winding portion 3014 are set to, for example, 4.

Furthermore, the primary-side third winding portion 3013 and the primary-side fourth winding portion 3014 are connected in series through a via (not illustrated). The primary-side first winding portion 3011 and the primary-side third winding portion 3013 are connected in parallel through a via (not illustrated). The primary-side second winding portion 3012 and the primary-side fourth winding portion 3014 are connected in parallel through a via (not illustrated).

The first winding capacitance C1 is a winding capacitance between the primary-side first winding portion 3011 and the secondary-side first winding portion 3021. The second winding capacitance C2 is a winding capacitance between the primary-side third winding portion 3013 and the secondary-side first winding portion 3021. The third winding capacitance C3 is a winding capacitance between the primary-side third winding portion 3013 and the primary-side fourth winding portion 3014.

Moreover, the transformer 300 has a fourth winding capacitance C4 and a fifth winding capacitance C5 in addition to the first winding capacitance C1, the second winding capacitance C2, and the third winding capacitance C3.

The fourth winding capacitance C4 is a winding capacitance between the primary-side fourth winding portion 3014 and the secondary-side second winding portion 3022. The fifth winding capacitance C5 is a winding capacitance between the primary-side second winding portion 3012 and the secondary-side second winding portion 3022.

The multilayer substrate 100 of the fourteenth embodiment is configured as described above. In the fourteenth embodiment, similar effects to those of the first embodiment are also achieved.

### Fifteenth Embodiment

In the fifteenth embodiment, the configuration of the transformer 300 differs from that in the fourteenth embodiment. The other configurations are similar to those in the fourteenth embodiment.

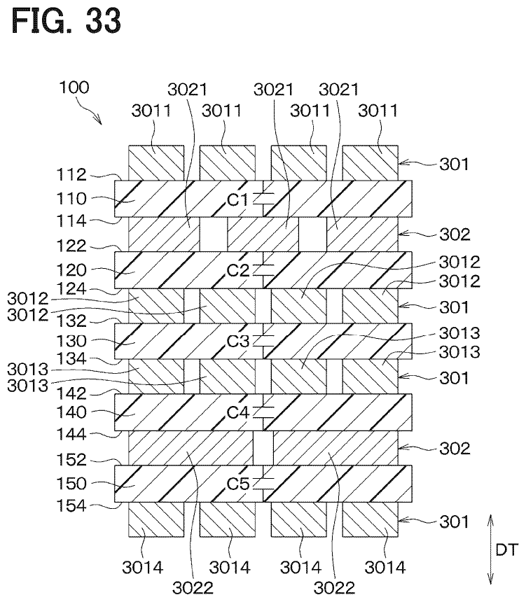

Specifically, as illustrated in FIG. 33, the primary-side first winding portion 3011 is disposed on the first front surface 112. The turns of the primary-side first winding portion 3011 are set to, for example, 4.

The primary-side second winding portion 3012 is disposed on the second rear surface 124 and the third front surface 132. The turns of the primary-side second winding portion 3012 are set to, for example, 4.

The primary-side third winding portion 3013 is disposed on the third rear surface 134 and the fourth front surface 142. The turns of the primary-side third winding portion 3013 are set to, for example, 4.

The primary-side fourth winding portion 3014 is disposed on the fifth rear surface 154. The turns of the primary-side fourth winding portion 3014 are set to, for example, 4.

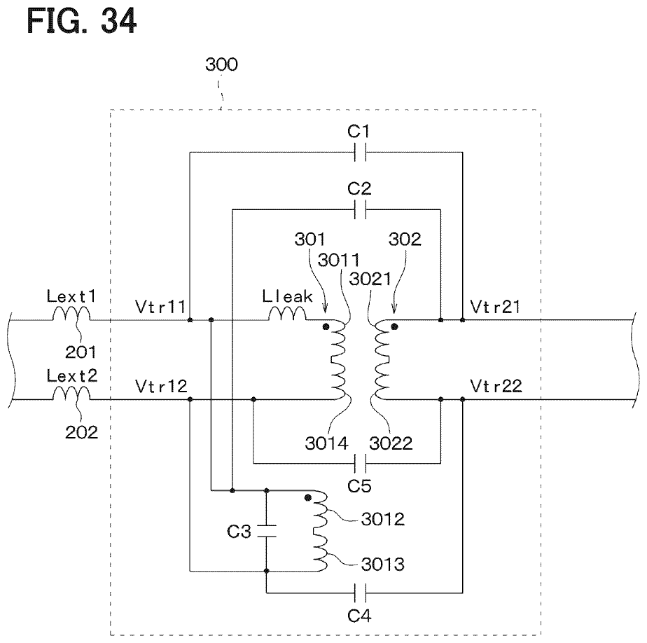

As illustrated in FIG. 34, the primary-side first winding portion 3011 and the primary-side second winding portion 3012 are connected in parallel through a via (not illustrated). The primary-side first winding portion 3011 and the primary-side fourth winding portion 3014 are connected in series through a via (not illustrated). The primary-side second winding portion 3012 and the primary-side third winding portion 3013 are connected in series through a via (not illustrated). The primary-side third winding portion 3013 and the primary-side fourth winding portion 3014 are connected in parallel through a via (not illustrated).

Furthermore, the winding directions of the primary-side first winding portion 3011, the primary-side second winding portion 3012, and the secondary-side first winding portion 3021 are set to be identical. The winding directions of the primary-side third winding portion 3013, the primary-side fourth winding portion 3014, and the secondary-side second winding portion 3022 are set to be identical.

The primary-side first winding portion 3011 and the primary-side second winding portion 3012 are connected to the first reactor 201. The primary-side third winding portion 3013 and the primary-side fourth winding portion 3014 are connected to the second reactor 202.

Moreover, as illustrated in FIGS. 33 and 34, the first winding capacitance C1 is a winding capacitance between the primary-side first winding portion 3011 and the secondary-side first winding portion 3021. The second winding capacitance C2 is a winding capacitance between the primary-side second winding portion 3012 and the secondary-side first winding portion 3021. The third winding capacitance C3 is a winding capacitance between the primary-side second winding portion 3012 and the primary-side third winding portion 3013. The fourth winding capacitance C4 is a winding capacitance between the primary-side third winding portion 3013 and the secondary-side second winding portion 3022. The fifth winding capacitance C5 is a winding capacitance between the primary-side fourth winding portion 3014 and the secondary-side second winding portion 3022.

The multilayer substrate 100 of the fifteenth embodiment is configured as described above. In the fifteenth embodiment, similar effects to those of the fourteenth embodiment are also achieved. Further, in the fifteenth embodiment, similar effects to those of the thirteenth embodiment are achieved.

### Sixteenth Embodiment

In the sixteenth embodiment, the multilayer substrate 100 includes a sixth substrate 160 and a seventh substrate 170 in addition to the first substrate 110, the second substrate 120, the third substrate 130, the fourth substrate 140, and the fifth substrate 150. Furthermore, the configuration of the transformer 300 differs from that in the thirteenth embodiment. The other configurations are similar to those in the thirteenth embodiment.

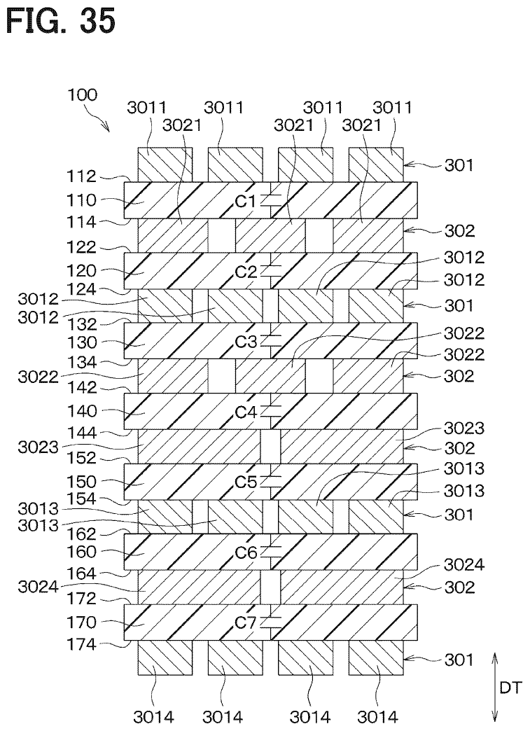

The sixth substrate 160 and the seventh substrate 170 are formed of, for example, a glass epoxy resin such as FR4. As illustrated in FIG. 35, the first substrate 110, the second substrate 120, the third substrate 130, the fourth substrate 140, the fifth substrate 150, the sixth substrate 160, and the seventh substrate 170 are arranged in this order in the thickness direction DT. Moreover, although not illustrated to avoid complexity, a resin such as a prepreg is embedded between the fifth substrate 150 and the sixth substrate 160. A resin such as a prepreg is embedded between the sixth substrate 160 and the seventh substrate 170.

The sixth substrate 160 has a sixth front surface 162 and a sixth rear surface 164. The sixth front surface 162 is a surface of the sixth substrate 160 on one side in the thickness direction DT, and faces the fifth rear surface 154 in the thickness direction DT. The sixth rear surface 164 is a surface of the sixth substrate 160 on the other side in the thickness direction DT, and is a surface of the sixth substrate 160 opposite to the sixth front surface 162.

The seventh substrate 170 has a seventh front surface 172 and a seventh rear surface 174. The seventh front surface 172 is a surface of the seventh substrate 170 on one side in the thickness direction DT, and faces the sixth rear surface 164 in the thickness direction DT. The seventh rear surface 174 is a surface of the seventh substrate 170 on the other side in the thickness direction DT, and is a surface of the seventh substrate 170 opposite to the seventh front surface 172.

The primary-side first winding portion 3011 is disposed on the first front surface 112. The turns of the primary-side first winding portion 3011 are set to, for example, 4.

The primary-side second winding portion 3012 is disposed on the second rear surface 124 and the third front surface 132. The turns of the primary-side second winding portion 3012 are set to, for example, 4.

Furthermore, the primary winding 301 includes a primary-side third winding portion 3013 and a primary-side fourth winding portion 3014 in addition to the primary-side first winding portion 3011 and the primary-side second winding portion 3012.

The primary-side third winding portion 3013 is disposed on the fifth rear surface 154 and the sixth front surface 162. The turns of the primary-side third winding portion 3013 are set to, for example, 4.

The primary-side fourth winding portion 3014 is disposed on the seventh rear surface 174. The turns of the primary-side fourth winding portion 3014 are set to, for example, 4.

The primary-side first winding portion 3011 and the primary-side second winding portion 3012 are connected in parallel through a via (not illustrated). The primary-side first winding portion 3011 and the primary-side fourth winding portion 3014 are connected in series through a via (not illustrated). The primary-side second winding portion 3012 and the primary-side third winding portion 3013 are connected in series through a via (not illustrated). The primary-side third winding portion 3013 and the primary-side fourth winding portion 3014 are connected in parallel through a via (not illustrated).

Furthermore, the primary-side first winding portion 3011 and the primary-side second winding portion 3012 are connected to the first reactor 201. The primary-side third winding portion 3013 and the primary-side fourth winding portion 3014 are connected to the second reactor 202.

The secondary-side first winding portion 3021 is disposed on the first rear surface 114 and the second front surface 122. The turns of the secondary-side first winding portion 3021 are set to, for example, 3.

The secondary-side second winding portion 3022 is disposed on the third rear surface 134 and the fourth front surface 142. The turns of the secondary-side second winding portion 3022 are set to, for example, 3.

The secondary-side third winding portion 3023 is disposed on the fourth rear surface 144 and the fifth front surface 152. The turns of the secondary-side third winding portion 3023 are set to, for example, 2.

The secondary-side fourth winding portion 3024 is disposed on the sixth rear surface 164 and the seventh front surface 172. The turns of the secondary-side fourth winding portion 3024 are set to, for example, 2.

Furthermore, the secondary-side first winding portion 3021 and the secondary-side second winding portion 3022 are connected in parallel through a via (not illustrated). The secondary-side first winding portion 3021 and the secondary-side fourth winding portion 3024 are connected in series through a via (not illustrated). The secondary-side second winding portion 3022 and the secondary-side third winding portion 3023 are connected in series through a via (not illustrated). The secondary-side third winding portion 3023 and the secondary-side fourth winding portion 3024 are connected in parallel through a via (not illustrated).

The winding directions of the primary-side first winding portion 3011, the primary-side second winding portion 3012, the secondary-side first winding portion 3021, and the secondary-side second winding portion 3022 are set to be identical. The winding directions of the primary-side third winding portion 3013, the primary-side fourth winding portion 3014, the secondary-side third winding portion 3023, and the secondary-side fourth winding portion 3024 are set to be identical.

Moreover, the secondary-side first winding portion 3021 and the secondary-side second winding portion 3022 are connected between the fifth switching element Q5 and the sixth switching element Q6. The secondary-side third winding portion 3023 and the secondary-side fourth winding portion 3024 are connected between the seventh switching element Q7 and the eighth switching element Q8.

The first winding capacitance C1 is a winding capacitance between the primary-side first winding portion 3011 and the secondary-side first winding portion 3021. The second winding capacitance C2 is a winding capacitance between the primary-side second winding portion 3012 and the secondary-side first winding portion 3021. The third winding capacitance C3 is a winding capacitance between the primary-side second winding portion 3012 and the secondary-side second winding portion 3022. The fourth winding capacitance C4 is a winding capacitance between the secondary-side second winding portion 3022 and the secondary-side third winding portion 3023. The fifth winding capacitance C5 is a winding capacitance between the primary-side third winding portion 3013 and the secondary-side third winding portion 3023.

Furthermore, the transformer 300 has a sixth winding capacitance C6 and a seventh winding capacitance C7 in addition to the first winding capacitance C1, the second winding capacitance C2, the third winding capacitance C3, the fourth winding capacitance C4, and the fifth winding capacitance C5.

The sixth winding capacitance C6 is a winding capacitance between the primary-side third winding portion 3013 and the secondary-side fourth winding portion 3024. The seventh winding capacitance C7 is a winding capacitance between the primary-side fourth winding portion 3014 and the secondary-side fourth winding portion 3024.

The multilayer substrate 100 of the sixteenth embodiment is configured as described above. In the sixteenth embodiment, similar effects to those of the thirteenth embodiment are also achieved.

### Seventeenth Embodiment

In the seventeenth embodiment, the configurations of the primary-side third winding portion 3013, the primary-side fourth winding portion 3014, the secondary-side third winding portion 3023, and the secondary-side fourth winding portion 3024 differ from those in the sixteenth embodiment. Furthermore, the configuration of the winding capacitance of the transformer 300 differs from that in the sixteenth embodiment. The other configurations are similar to those in the sixteenth embodiment.

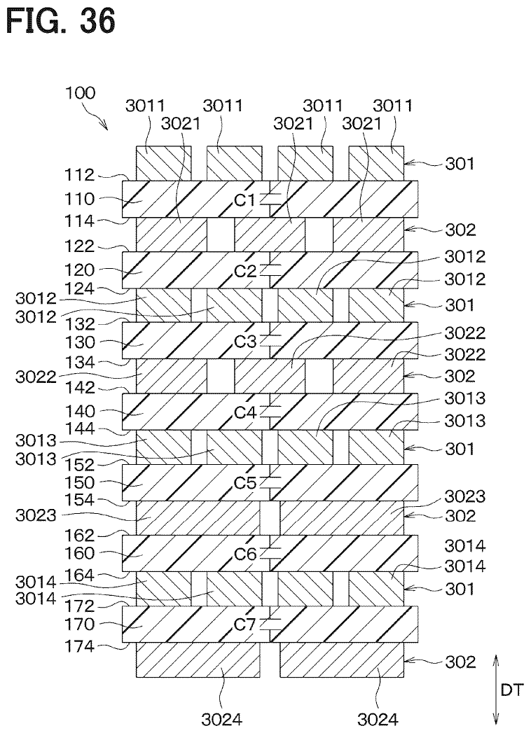

Specifically, as illustrated in FIG. 36, the primary-side third winding portion 3013 is disposed on the fourth rear surface 144 and the fifth front surface 152. The primary-side fourth winding portion 3014 is disposed on the sixth rear surface 164 and the seventh front surface 172.

The secondary-side third winding portion 3023 is disposed on the fifth rear surface 154 and the sixth front surface 162. The secondary-side fourth winding portion 3024 is disposed on the seventh rear surface 174.

Furthermore, the first winding capacitance C1 is a winding capacitance between the primary-side first winding portion 3011 and the secondary-side first winding portion 3021. The second winding capacitance C2 is a winding capacitance between the primary-side second winding portion 3012 and the secondary-side first winding portion 3021. The third winding capacitance C3 is a winding capacitance between the primary-side second winding portion 3012 and the secondary-side second winding portion 3022. The fourth winding capacitance C4 is a winding capacitance between the primary-side third winding portion 3013 and the secondary-side second winding portion 3022. The fifth winding capacitance C5 is a winding capacitance between the primary-side third winding portion 3013 and the secondary-side third winding portion 3023. The sixth winding capacitance C6 is a winding capacitance between the primary-side fourth winding portion 3014 and the secondary-side third winding portion 3023. The seventh winding capacitance C7 is a winding capacitance between the primary-side fourth winding portion 3014 and the secondary-side fourth winding portion 3024.

The multilayer substrate 100 of the seventeenth embodiment is configured as described above. In the seventeenth embodiment, similar effects to those of the sixteenth embodiment are also achieved.

### Eighteenth Embodiment

In the eighteenth embodiment, the configurations of the primary-side second winding portion 3012 and the secondary-side second winding portion 3022 differ from those in the first embodiment. The other configurations are similar to those in the first embodiment.

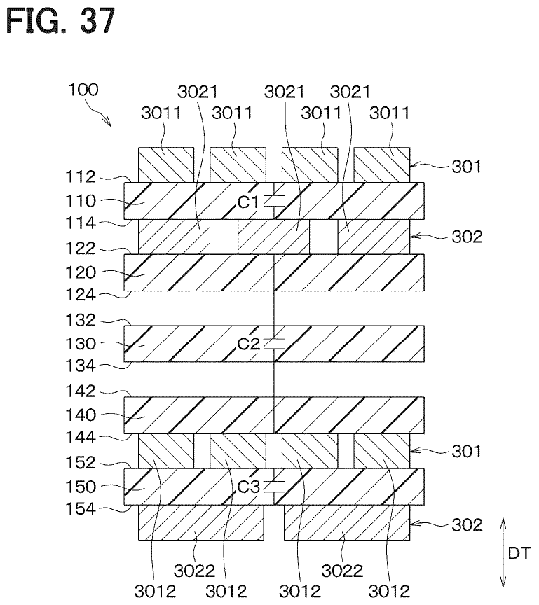

Specifically, as illustrated in FIG. 37, the primary-side second winding portion 3012 is disposed on the fourth rear surface 144 and the fifth front surface 152. The secondary-side second winding portion 3022 is disposed on the fifth rear surface 154. In this case, the second winding capacitance C2 is a winding capacitance between the primary-side second winding portion 3012 and the secondary-side first winding portion 3021. The third front surface 132 faces the secondary-side first winding portion 3021 in the thickness direction DT. Furthermore, the third rear surface 134 faces the primary-side second winding portion 3012 in the thickness direction DT.

The multilayer substrate 100 of the eighteenth embodiment is configured as described above. In the eighteenth embodiment, similar effects to those of the first embodiment are also achieved.

### Nineteenth Embodiment

In the nineteenth embodiment, the multilayer substrate 100 includes a sixth substrate 160 and a seventh substrate 170 in addition to the first substrate 110, the second substrate 120, the third substrate 130, the fourth substrate 140, and the fifth substrate 150. Furthermore, the configuration of the transformer 300 differs from that in the first embodiment. The other configurations are similar to those in the first embodiment.

The sixth substrate 160 and the seventh substrate 170 are similar to the sixth substrate 160 and the seventh substrate 170 of the sixteenth embodiment. Therefore, description of the sixth substrate 160 and the seventh substrate 170 is omitted.

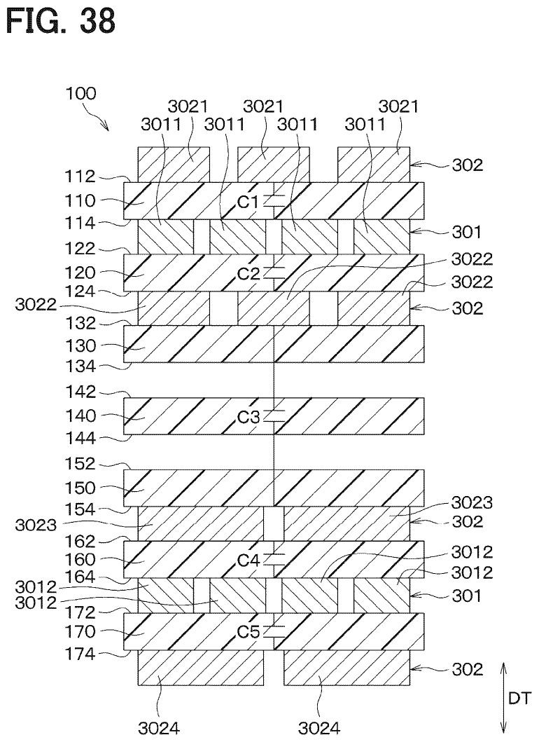

In the transformer 300, the primary-side first winding portion 3011 is disposed on the first rear surface 114 and the second front surface 122 as illustrated in FIG. 38. The primary-side second winding portion 3012 is disposed on the sixth rear surface 164 and the seventh front surface 172. The primary-side first winding portion 3011 and the primary-side second winding portion 3012 are connected in series through a via (not illustrated).

The secondary-side first winding portion 3021 is disposed on the first front surface 112. The turns of the secondary-side first winding portion 3021 are set to, for example, 3.

The secondary-side second winding portion 3022 is disposed on the second rear surface 124 and the third front surface 132. The turns of the secondary-side second winding portion 3022 are set to, for example, 3.

Furthermore, the secondary winding 302 includes a secondary-side third winding portion 3023 and a secondary-side fourth winding portion 3024 in addition to the secondary-side first winding portion 3021 and the secondary-side second winding portion 3022.

The secondary-side third winding portion 3023 is disposed on the fifth rear surface 154 and the sixth front surface 162. The turns of the secondary-side third winding portion 3023 are set to, for example, 2.

The secondary-side fourth winding portion 3024 is disposed on the seventh rear surface 174. The turns of the secondary-side fourth winding portion 3024 are set to, for example, 2.

Therefore, the primary winding 301 and the secondary winding 302 are not disposed on the third rear surface 134, the fourth front surface 142, the fourth rear surface 144, and the fifth front surface 152.

The secondary-side first winding portion 3021 and the secondary-side second winding portion 3022 are connected in parallel through a via (not illustrated). The secondary-side first winding portion 3021 and the secondary-side fourth winding portion 3024 are connected in series through a via (not illustrated). The secondary-side second winding portion 3022 and the secondary-side third winding portion 3023 are connected in series through a via (not illustrated). The secondary-side third winding portion 3023 and the secondary-side fourth winding portion 3024 are connected in parallel through a via (not illustrated).

Furthermore, the first winding capacitance C1 is a winding capacitance between the primary-side first winding portion 3011 and the secondary-side first winding portion 3021. The second winding capacitance C2 is a winding capacitance between the primary-side first winding portion 3011 and the secondary-side second winding portion 3022. The third winding capacitance C3 is a winding capacitance between the secondary-side second winding portion 3022 and the secondary-side third winding portion 3023.

The transformer 300 has a fourth winding capacitance C4 and a fifth winding capacitance C5 in addition to the first winding capacitance C1, the second winding capacitance C2, and the third winding capacitance C3.

The fourth winding capacitance C4 is a winding capacitance between the primary-side second winding portion 3012 and the secondary-side third winding portion 3023. The fifth winding capacitance C5 is a winding capacitance between the primary-side second winding portion 3012 and the secondary-side fourth winding portion 3024.

The multilayer substrate 100 of the nineteenth embodiment is configured as described above. In the nineteenth embodiment, similar effects to those of the first embodiment are also achieved.

### Twentieth Embodiment

In the twentieth embodiment, the configurations of the first reactor 201, the second reactor 202, and the transformer 300 differ from those in the first embodiment. The other configurations are similar to those in the first embodiment.

Here, it is assumed that the secondary-side switching operation SW2 has been performed in the multilayer substrate 100. At this point, Δ(Vtr11−Vtr21) is expressed by the above relational expression (1-17). Δ(Vtr12−Vtr22) is expressed by the above relational expression (1-20).

Furthermore, Δ(Vtr11−Vtr21) when the secondary-side switching operation SW2 is performed in the case of x=0.5 is expressed by the following relational expression (3-1). Δ(Vtr12−Vtr22) when the secondary-side switching operation SW2 is performed in the case of x=0.5 is expressed by the following relational expression (3-2).

$$Δ ( Vtr 11 - Vtr 21 ) = N \times Δ V 2 \times \frac{Lext}{Lext + Lleak} - Δ V 2 \qquad ( 3 - 1 )$$

$$Δ ( Vtr 12 - Vtr 22 ) = - N \times Δ V 2 \times \frac{Lext}{Lext + Lleak} + Δ V 2 \qquad ( 3 - 2 )$$

When N×Lext/(Lext+Lleak)−1=0, Δ(Vtr11−Vtr21) and Δ(Vtr12−Vtr22) become 0. When N×Lext/(Lext+Lleak)−1=0, Lext=Lleak/(N−1). Thus, when Lext=Lleak/(N−1), Δ(Vtr11−Vtr21) and Δ(Vtr12−Vtr22) become 0.

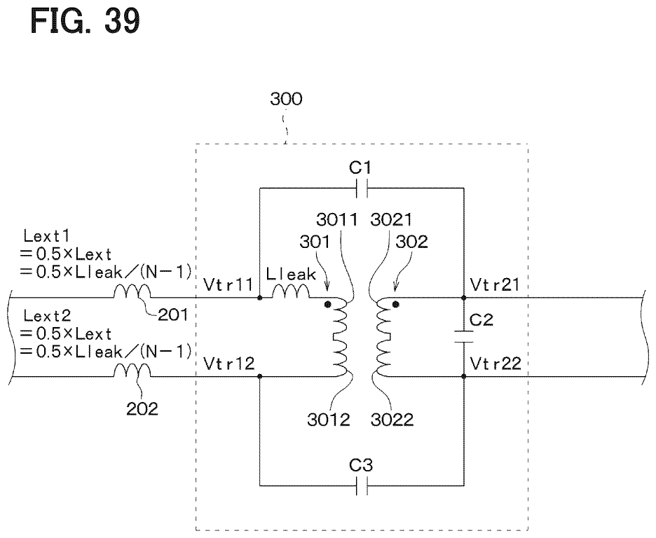

Therefore, as illustrated in FIG. 39, the first reactor 201, the second reactor 202, and the transformer 300 are formed so as to satisfy the following relational expression (3-3).

$$Lext = Lext 1 + Lext 2 ; Lext 1 = 0.5 \times Lext ; Lext 2 = 0.5 \times Lext ; \qquad ( 3 - 3 )$$

$$Lext = Lleak / ( N - 1 )$$

The multilayer substrate 100 of the twentieth embodiment is configured as described above. In the twentieth embodiment, similar effects to those of the first embodiment are also achieved. Furthermore, in the twentieth embodiment, the following effects are also achieved.

When the above relational expression (3-3) is satisfied, Δ(Vtr11−Vtr21) when the secondary-side switching operation SW2 is performed becomes 0. Thus, at this time, the current flowing through the first winding capacitance C1, which is the winding capacitance between the one end of the primary winding 301 and the one end of the secondary winding 302, becomes 0. Therefore, the loss of the ER core 103 is reduced.

Δ(Vtr12−Vtr22) when the secondary-side switching operation SW2 is performed becomes 0. Thus, at this time, the current flowing in the third winding capacitance C3, which is the winding capacitance between the other end of the primary winding 301 and the other end of the secondary winding 302, becomes 0. Accordingly, the loss of the ER core 103 is reduced.

### Twenty-First Embodiment

In the twenty-first embodiment, the configurations of the first reactor 201, the second reactor 202, and the transformer 300 differ from those in the third embodiment. The other configurations are similar to those in the third embodiment.

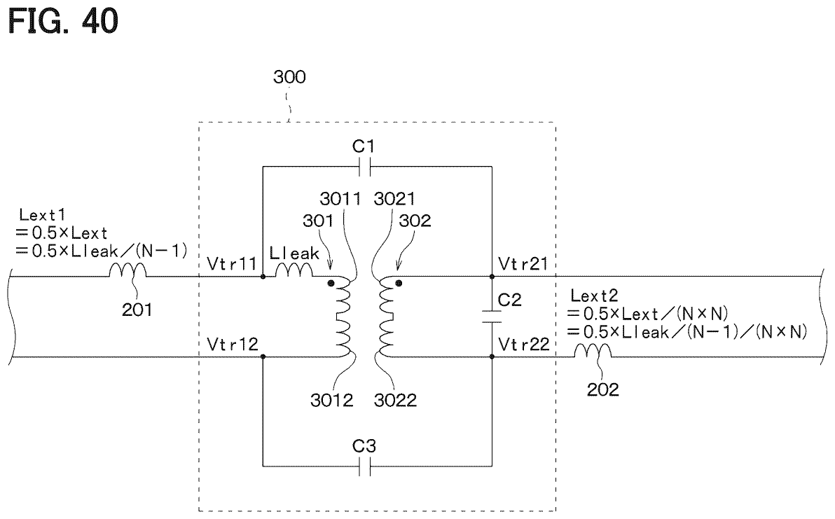

Specifically, as illustrated in FIG. 40, the first reactor 201, the second reactor 202, and the transformer 300 are formed so as to satisfy the following relational expression (4).

$$Lext = Lext 1 + Lext 2 \times N \times N ; Lext 1 = 0.5 \times Lext ; \qquad ( 4 )$$

$$Lext 2 = 0.5 \times Lext / ( N \times N ) ; Lext = Lleak / ( N - 1 )$$

The multilayer substrate 100 of the twenty-first embodiment is configured as described above. In the twenty-first embodiment, similar effects to those of the third embodiment are also achieved. The twenty-first embodiment achieves similar effects to those of the twentieth embodiment.

### Twenty-Second Embodiment

In the twenty-second embodiment, the configurations of the primary-side first winding portion 3011 and the secondary-side first winding portion 3021 differ from those in the first embodiment. The other configurations are similar to those in the first embodiment.

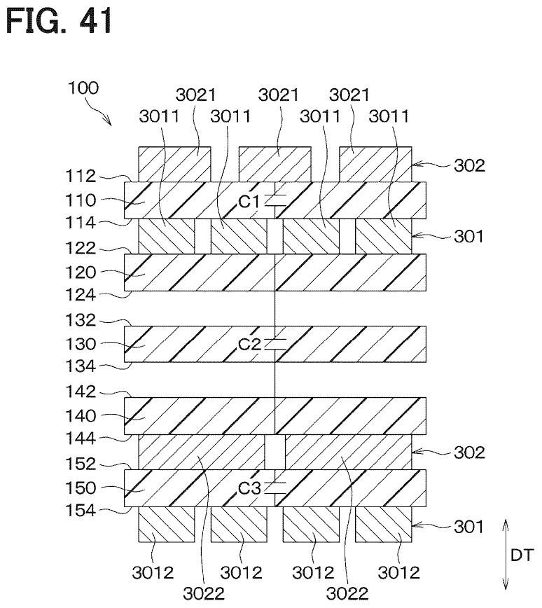

Specifically, as illustrated in FIG. 41, the primary-side first winding portion 3011 is disposed on the first rear surface 114 and the second front surface 122. The secondary-side first winding portion 3021 is disposed on the first front surface 112. In this case, the second winding capacitance C2 is a winding capacitance between the primary-side first winding portion 3011 and the secondary-side second winding portion 3022. The third front surface 132 faces the primary-side first winding portion 3011 in the thickness direction DT. Furthermore, the third rear surface 134 faces the secondary-side second winding portion 3022 in the thickness direction DT.

The multilayer substrate 100 of the twenty-second embodiment is configured as described above. In the twenty-second embodiment, similar effects to those of the first embodiment are also achieved.

### Twenty-Third Embodiment

In the twenty-third embodiment, the configurations of the primary-side first winding portion 3011 and the secondary-side first winding portion 3021 differ from those in the eighteenth embodiment. The other configurations are similar to those in the eighteenth embodiment.

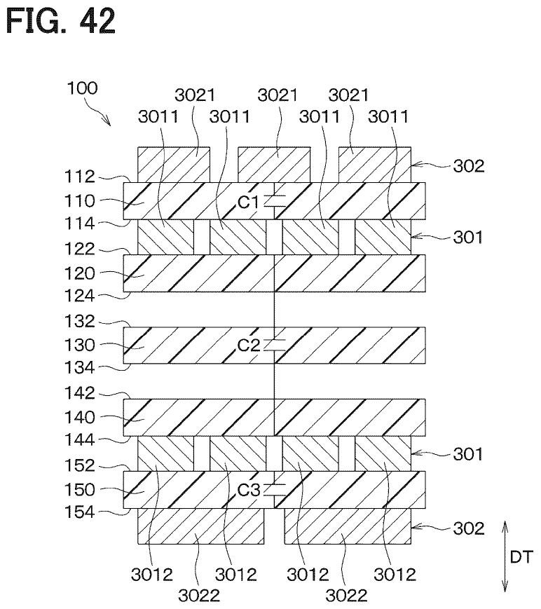

Specifically, as illustrated in FIG. 42, the primary-side first winding portion 3011 is disposed on the first rear surface 114 and the second front surface 122. The secondary-side first winding portion 3021 is disposed on the first front surface 112. In this case, the second winding capacitance C2 is a winding capacitance between the primary-side first winding portion 3011 and the primary-side second winding portion 3012. The third front surface 132 faces the primary-side first winding portion 3011 in the thickness direction DT. Furthermore, the third rear surface 134 faces the primary-side second winding portion 3012 in the thickness direction DT.

The multilayer substrate 100 of the twenty-third embodiment is configured as described above. In the twenty-third embodiment, similar effects to those of the eighteenth embodiment are also achieved.

### Twenty-Fourth Embodiment

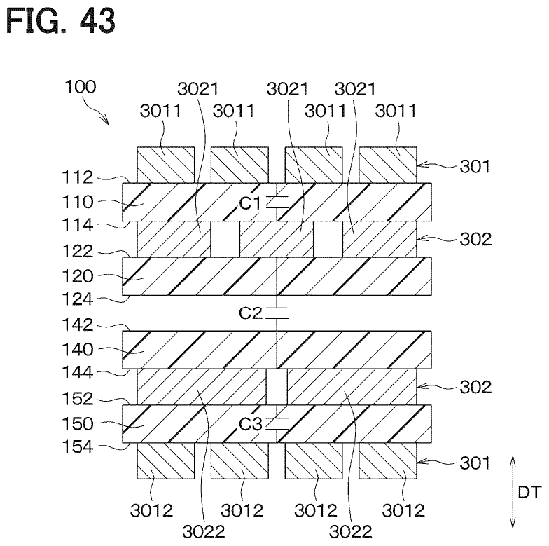

In the twenty-fourth embodiment, as illustrated in FIG. 43, the multilayer substrate 100 does not include the third substrate 130. The other configurations are similar to those in the first embodiment.

In this case, the second rear surface 124, which is the surface of the second substrate 120 opposite to the secondary-side first winding portion 3021, faces the fourth front surface 142, which is the surface of the fourth substrate 140 opposite to the secondary-side second winding portion 3022, in the thickness direction DT. The primary winding 301 and the secondary winding 302 are not disposed on the second rear surface 124 and the fourth front surface 142.

The multilayer substrate 100 of the twenty-fourth embodiment is configured as described above. In the twenty-fourth embodiment, similar effects to those of the first embodiment are also achieved.

### Twenty-Fifth Embodiment

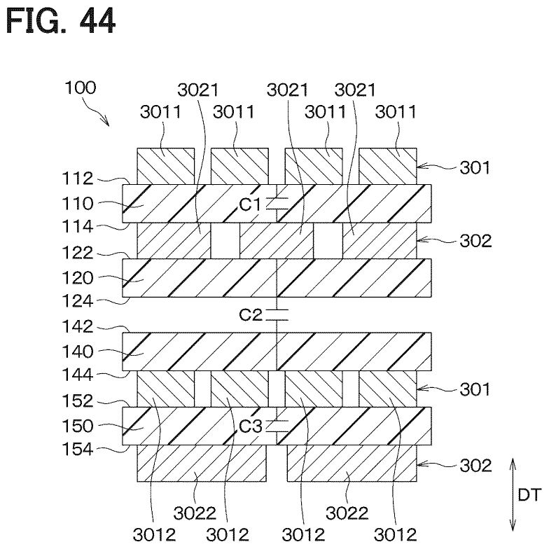

In the twenty-fifth embodiment, as illustrated in FIG. 44, the multilayer substrate 100 does not include the third substrate 130. The other configurations are similar to those in the eighteenth embodiment.

In this case, the second rear surface 124, which is the surface of the second substrate 120 opposite to the secondary-side first winding portion 3021, faces the fourth front surface 142, which is the surface of the fourth substrate 140 opposite to the primary-side second winding portion 3012, in the thickness direction DT. The primary winding 301 and the secondary winding 302 are not disposed on the second rear surface 124 and the fourth front surface 142.

The multilayer substrate 100 of the twenty-fifth embodiment is configured as described above. In the twenty-fifth embodiment, similar effects to those of the eighteenth embodiment are also achieved.

### Twenty-Sixth Embodiment

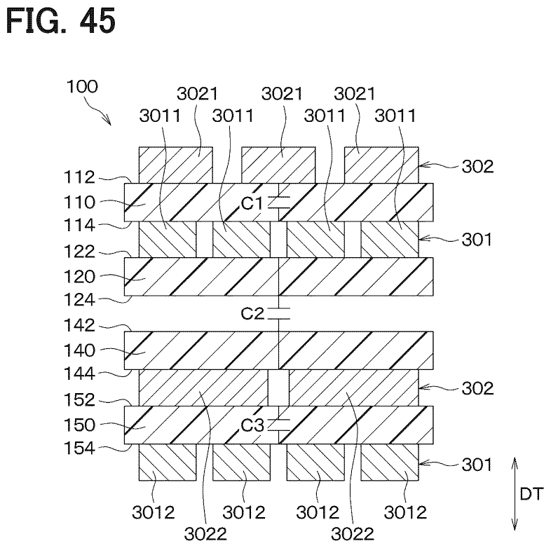

In the twenty-sixth embodiment, as illustrated in FIG. 45, the multilayer substrate 100 does not include the third substrate 130. The other configurations are similar to those in the twenty-second embodiment.

In this case, the second rear surface 124, which is the surface of the second substrate 120 opposite to the primary-side first winding portion 3011, faces the fourth front surface 142, which is the surface of the fourth substrate 140 opposite to the secondary-side second winding portion 3022, in the thickness direction DT. The primary winding 301 and the secondary winding 302 are not disposed on the second rear surface 124 and the fourth front surface 142.

The multilayer substrate 100 of the twenty-sixth embodiment is configured as described above. In the twenty-sixth embodiment, similar effects to those of the twenty-second embodiment are also achieved.

### Twenty-Seventh Embodiment

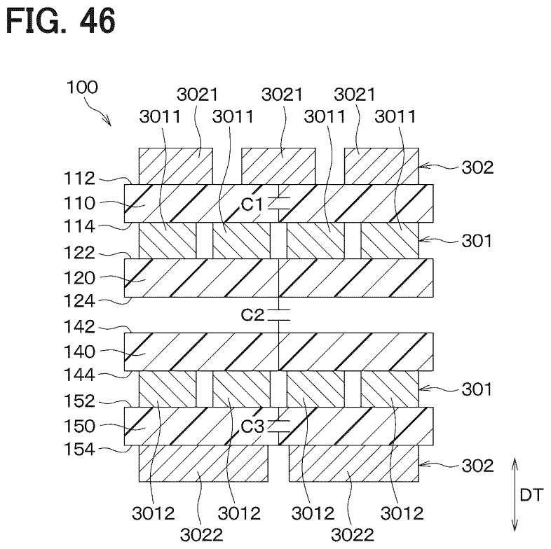

In the twenty-seventh embodiment, as illustrated in FIG. 46, the multilayer substrate 100 does not include the third substrate 130. The other configurations are similar to those in the twenty-third embodiment.

In this case, the second rear surface 124, which is the surface of the second substrate 120 opposite to the primary-side first winding portion 3011, faces the fourth front surface 142, which is the surface of the fourth substrate 140 opposite to the primary-side second winding portion 3012, in the thickness direction DT. The primary winding 301 and the secondary winding 302 are not disposed on the second rear surface 124 and the fourth front surface 142.

The multilayer substrate 100 of the twenty-seventh embodiment is configured as described above. In the twenty-seventh embodiment, similar effects to those of the twenty-third embodiment are also achieved.

### Other Embodiments

The present disclosure is not limited to the above embodiments, and can be appropriately modified from the above embodiments. It goes without saying that in each of the above embodiments, the elements constituting the embodiment are not necessarily essential except for a case where it is explicitly stated that the elements are particularly essential and a case where the elements are considered to be obviously essential in principle.

In the first embodiment, the primary winding 301 includes a primary-side first winding portion 3011 and a primary-side second winding portion 3012. However, the primary winding 301 may include only the primary-side first winding portion 3011 without including the primary-side second winding portion 3012. The secondary winding 302 includes a secondary-side first winding portion 3021 and a secondary-side second winding portion 3022. However, the secondary winding 302 may include only the secondary-side first winding portion 3021 without including the secondary-side second winding portion 3022.

In each of the above embodiments, the number of reactors connected to the end of the transformer 300 is set to 2 to 4. However, the number of reactors connected to the end of the transformer 300 is not limited to 2 to 4, and may be 5 or more.

In each of the above embodiments, the first reactor 201 and the second reactor 202 are formed inside the multilayer substrate 100 or on the multilayer substrate 100. However, the first reactor 201 and the second reactor 202 may be formed outside the multilayer substrate 100.

In each of the above embodiments, the turns of the primary winding 301 are set to 8. However, the turns of the primary winding 301 are not limited to 8, and may be any number. The turns of the secondary winding 302 are set to 5. However, the turns of the secondary winding 302 are not limited to 5, and may be any number.

The above embodiments may be combined as appropriate.

What is claimed is:

1. A multilayer substrate comprising:
a first substrate;
a second substrate;
a transformer including a primary winding and a secondary winding and having a first end and a second end;
a first reactor connected to the first end of the transformer; and
a second reactor connected to the second end of the transformer, wherein
the primary winding includes a primary-side first winding portion and a primary-side second winding portion,
the secondary winding includes a secondary-side first winding portion and a secondary-side second winding portion,
the primary-side first winding portion, the primary-side second winding portion, the secondary-side first winding portion, and the secondary-side second winding portion are formed in a spiral shape extending on a plane orthogonal to a thickness direction of the first substrate,
the first substrate and the second substrate are arranged in the thickness direction,
the primary-side first winding portion is disposed on one surface of the first substrate,
the secondary-side first winding portion is disposed on another surface of the first substrate that is opposite to the one surface on which the primary-side first winding portion is disposed,
the primary-side second winding portion is disposed on one surface of the second substrate, and
the secondary-side second winding portion is disposed on another surface of the second substrate that is opposite to the one surface on which the primary-side second winding portion is disposed.

2. The multilayer substrate according to claim 1, further comprising a core, wherein
the core penetrates the first substrate and the second substrate and is surrounded by the primary winding and the secondary winding.

3. The multilayer substrate according to claim 1, wherein
the first end is one end of the primary winding, and
the second end is another end of the primary winding.

4. The multilayer substrate according to claim 1, wherein
the first end is one end of the secondary winding, and
the second end is another end of the secondary winding.

5. The multilayer substrate according to claim 3, wherein
when an inductance of the first reactor is defined as Lext1, an inductance of the second reactor is defined as Lext2, and a leakage inductance of the transformer is defined as Lleak, the transformer, the first reactor, and the second reactor satisfy relationships of:
$$Lext = Lext 1 + Lext 2 ; and$$
$$Lext / Lleak \geq 0.5 .$$

6. The multilayer substrate according to claim 3, wherein
when a variable is defined as x, an inductance of the first reactor is defined as Lext1, and an inductance of the second reactor is defined as Lext2, the first reactor and the second reactor satisfy relationships of:
$$Lext = Lext 1 + Lext 2 ;$$
$$Lext 1 = x \times Lext ;$$
$$Lext 2 = ( 1 - x ) \times Lext ; and$$
$$0.3 \leq x \leq 0.7 .$$

7. The multilayer substrate according to claim 3, wherein
when an inductance of the first reactor is defined as Lext1, an inductance of the second reactor is defined as Lext2, a leakage inductance of the transformer is defined as Lleak, and a ratio of turns of the secondary winding to turns of the primary winding is defined as N, the transformer, the first reactor, and the second reactor satisfy relationships of:
$$Lext = Lext 1 + Lext 2 ;$$
$$Lext 1 = 0.5 \times Lext ;$$
$$Lext 2 = 0.5 \times Lext ; and$$
$$Lext = Lleak / ( N - 1 ) .$$

8. The multilayer substrate according to claim 1, wherein
when a voltage is applied to the primary winding, a polarity of a voltage at one end of the primary winding is opposite to a polarity of a voltage at one end of the secondary winding,
the first end is one end of the primary winding, and
the second end is one end of the secondary winding.

9. The multilayer substrate according to claim 8, wherein
when an inductance of the first reactor is defined as Lext1, an inductance of the second reactor is defined as Lext2, a leakage inductance of the transformer is defined as Lleak, and a ratio of turns of the secondary winding to turns of the primary winding is defined as N, the transformer, the first reactor, and the second reactor satisfy relationships of:
$$Lext = Lext 1 + Lext 2 \times N \times N ; and$$
$$Lext = Lleak \geq 0.5 .$$

10. The multilayer substrate according to claim 8, wherein
when a variable is defined as x, an inductance of the first reactor is defined as Lext1, an inductance of the second reactor is defined as Lext2, and a ratio of turns of the secondary winding to turns of the primary winding is defined as N, the first reactor and the second reactor satisfy relationships of:
$$Lext = Lext 1 + Lext 2 \times N \times N ;$$
$$Lext 1 = x \times Lext ;$$
$$Lext 2 = ( 1 - x ) \times Lext / ( N \times N ) ; and$$
$$0.3 \leq x \leq 0.7 .$$

11. The multilayer substrate according to claim 8, wherein
when an inductance of the first reactor is defined as Lext1, an inductance of the second reactor is defined as Lext2, a leakage inductance of the transformer is defined as Lleak, and a ratio of turns of the secondary winding to turns of the primary winding is defined as N, the transformer, the first reactor, and the second reactor satisfy relationships of:
$$Lext = Lext 1 + Lext 2 \times N \times N ;$$
$$Lext 1 = 0.5 \times Lext ;$$
$$Lext 2 = 0.5 \times Lext / ( N \times N ) ; and$$
$$Lext = Lleak / ( N - 1 ) .$$

12. The multilayer substrate according to claim 1, wherein
the primary-side first winding portion and the primary-side second winding portion are connected in series, and
the secondary-side first winding portion and the secondary-side second winding portion are connected in series.

13. The multilayer substrate according to claim 12, further comprising a third substrate, wherein
the third substrate is disposed between the first substrate and the second substrate, and
the third substrate is free of the primary winding and the secondary winding.

14. The multilayer substrate according to claim 13, wherein
a front surface of the third substrate faces the secondary-side first winding portion in the thickness direction,
a rear surface of the third substrate faces the secondary-side second winding portion in the thickness direction, and
a winding direction of the secondary-side first winding portion differs from a winding direction of the secondary-side second winding portion.

15. The multilayer substrate according to claim 13, wherein
a front surface of the third substrate faces the secondary-side first winding portion in the thickness direction,
a rear surface of the third substrate faces the primary-side second winding portion in the thickness direction, and
a winding direction of the secondary-side first winding portion differs from a winding direction of the primary-side second winding portion.

16. The multilayer substrate according to claim 13, wherein
a front surface of the third substrate faces the primary-side first winding portion in the thickness direction,
a rear surface of the third substrate faces the secondary-side second winding portion in the thickness direction, and
a winding direction of the primary-side first winding portion differs from a winding direction of the secondary-side second winding portion.

17. The multilayer substrate according to claim 13, wherein
a front surface of the third substrate faces the primary-side first winding portion in the thickness direction,
a rear surface of the third substrate faces the primary-side second winding portion in the thickness direction, and
a winding direction of the primary-side first winding portion differs from a winding direction of the primary-side second winding portion.

18. The multilayer substrate according to claim 12, further comprising a third substrate and a fourth substrate, wherein
the third substrate is connected to a side of the secondary-side first winding portion opposite to the first substrate,
a surface of the third substrate opposite to the secondary-side first winding portion is free of the primary winding and the secondary winding,
the fourth substrate is connected to a side of the secondary-side second winding portion opposite to the second substrate,
a surface of the fourth substrate opposite to the secondary-side second winding portion is free of the primary winding and the secondary winding,
the surface of the third substrate opposite to the secondary-side first winding portion faces the surface of the fourth substrate opposite to the secondary-side second winding portion in the thickness direction, and
a winding direction of the secondary-side first winding portion differs from a winding direction of the secondary-side second winding portion.

19. The multilayer substrate according to claim 12, further comprising a third substrate and a fourth substrate, wherein
the third substrate is connected to a side of the secondary-side first winding portion opposite to the first substrate,
a surface of the third substrate opposite to the secondary-side first winding portion is free of the primary winding and the secondary winding,
the fourth substrate is connected to a side of the primary-side second winding portion opposite to the second substrate,
a surface of the fourth substrate opposite to the primary-side second winding portion is free of the primary winding and the secondary winding,
the surface of the third substrate opposite to the secondary-side first winding portion faces the surface of the fourth substrate opposite to the primary-side second winding portion in the thickness direction, and
a winding direction of the secondary-side first winding portion differs from a winding direction of the primary-side second winding portion.

20. The multilayer substrate according to claim 12, further comprising a third substrate and a fourth substrate, wherein
the third substrate is connected to a side of the primary-side first winding portion opposite to the first substrate,
a surface of the third substrate opposite to the primary-side first winding portion is free of the primary winding and the secondary winding,
the fourth substrate is connected to a side of the secondary-side second winding portion opposite to the second substrate,
a surface of the fourth substrate opposite to the secondary-side second winding portion is free of the primary winding and the secondary winding,
the surface of the third substrate opposite to the primary-side first winding portion faces the surface of the fourth substrate opposite to the secondary-side second winding portion in the thickness direction, and
a winding direction of the primary-side first winding portion differs from a winding direction of the secondary-side second winding portion.

21. The multilayer substrate according to claim 12, further comprising a third substrate and a fourth substrate, wherein
the third substrate is connected to a side of the primary-side first winding portion opposite to the first substrate,
a surface of the third substrate opposite to the primary-side first winding portion is free of the primary winding and the secondary winding,
the fourth substrate is connected to a side of the primary-side second winding portion opposite to the second substrate,
a surface of the fourth substrate opposite to the primary-side second winding portion is free of the primary winding and the secondary winding,
the surface of the third substrate opposite to the primary-side first winding portion faces the surface of the fourth substrate opposite to the primary-side second winding portion in the thickness direction, and
a winding direction of the primary-side first winding portion differs from a winding direction of the primary-side second winding portion.

22. The multilayer substrate according to claim 1, wherein
winding directions of the primary-side first winding portion and the secondary-side first winding portion are set to be identical, and
winding directions of the primary-side second winding portion and the secondary-side second winding portion are set to be identical.

23. The multilayer substrate according to claim 1, further comprising a third substrate, a fourth substrate, and a fifth substrate, wherein
the first substrate, the second substrate, the third substrate, the fourth substrate, and the fifth substrate are arranged in order in the thickness direction,
the secondary winding further includes a secondary-side third winding portion and a secondary-side fourth winding portion,
the secondary-side third winding portion and the secondary-side fourth winding portion are formed in a spiral shape extending on a plane orthogonal to the thickness direction,
the secondary-side first winding portion is disposed on a first front surface of the first substrate,
the primary-side first winding portion is disposed on a first rear surface of the first substrate and a second front surface of the second substrate,
the secondary-side second winding portion is disposed on a second rear surface of the second substrate and a third front surface of the third substrate,
the secondary-side third winding portion is disposed on a third rear surface of the third substrate and a fourth front surface of the fourth substrate,
the primary-side second winding portion is disposed on a fourth rear surface of the fourth substrate and a fifth front surface of the fifth substrate,
the secondary-side fourth winding portion is disposed on a fifth rear surface of the fifth substrate,
the primary-side first winding portion and the primary-side second winding portion are connected in series,
the secondary-side first winding portion and the secondary-side second winding portion are connected in parallel,
the secondary-side first winding portion and the secondary-side fourth winding portion are connected in series,
the secondary-side second winding portion and the secondary-side third winding portion are connected in series,
the secondary-side third winding portion and the secondary-side fourth winding portion are connected in parallel,
winding directions of the primary-side first winding portion, the secondary-side first winding portion, and the secondary-side second winding portion are set to be identical, and
winding directions of the primary-side second winding portion, the secondary-side third winding portion, and the secondary-side fourth winding portion are set to be identical.

24. The multilayer substrate according to claim 1, further comprising a third substrate, a fourth substrate, and a fifth substrate, wherein
the first substrate, the second substrate, the third substrate, the fourth substrate, and the fifth substrate are arranged in order in the thickness direction,
the primary winding further includes a primary-side third winding portion and a primary-side fourth winding portion,
the primary-side third winding portion and the primary-side fourth winding portion are formed in a spiral shape extending on a plane orthogonal to the thickness direction,
the primary-side first winding portion is disposed on a first front surface of the first substrate,
the secondary-side first winding portion is disposed on a first rear surface of the first substrate and a second front surface of the second substrate,
the primary-side second winding portion is disposed on a second rear surface of the second substrate and a third front surface of the third substrate,
the primary-side third winding portion is disposed on a third rear surface of the third substrate and a fourth front surface of the fourth substrate,
the secondary-side second winding portion is disposed on a fourth rear surface of the fourth substrate and a fifth front surface of the fifth substrate,
the primary-side fourth winding portion is disposed on a fifth rear surface of the fifth substrate,
the secondary-side first winding portion and the secondary-side second winding portion are connected in series,
the primary-side first winding portion and the primary-side second winding portion are connected in parallel,
the primary-side first winding portion and the primary-side fourth winding portion are connected in series,
the primary-side second winding portion and the primary-side third winding portion are connected in series,
the primary-side third winding portion and the primary-side fourth winding portion are connected in parallel,
winding directions of the primary-side first winding portion, the primary-side second winding portion, and the secondary-side first winding portion are set to be identical, and
winding directions of the primary-side third winding portion, the primary-side fourth winding portion, and the secondary-side second winding portion are set to be identical.
